(19) United States
(12) Patent Application Publication
(10) Pub. No.: US 2005/0172005 A1
(43) Pub. Date: Aug. 4, 2005

(54) Forestalling use of duplicate volume identifiers

(76) Inventor: Kevin Michael Goodwin, Santa Barbara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/767,435

(22) Filed: Jan. 30, 2004

(51) Int. Cl. G06F 15/16

(52) U.S. Cl. 709/211

(57) ABSTRACT

A method, of forestalling use of duplicate volume identifiers (volume-IDs) (where at least a portion of a volume is on a storage-device such that communication between an input/output (I/O) initiator and the storage-device takes place via a stack of device objects representing the volume), may include: determining that a first volume-ID intended for a first volume is not available for use; and restricting access to the first volume by one of putting the first volume into a read-only-state in which access is restricted to read-only type access, and blocking I/O to the first volume.

### BACKGROUND OF THE INVENTION

A volume is a logical apportionment of storage space on one or more physical data storage-devices. There are computer networks in which every volume can be directly accessible by many, if not all, computers connected to the network. An example of such a computer network is a storage area network (SAN).

A single logical unit (LUN) can contain all, or part of, one or more volumes. In general, it is known to restrict or block access to a LUN, which has the effect of blocking access to the portions of the corresponding volume(s).

Where multiple users/computers can write to the same volume, be it in a SAN or otherwise, a significant potential exists for corrupting the data on the volume. A policy to permit only one such computer to have write-type access in addition to full read-type access, while all other such computers have only read-access, can prevent such data corruption.

It is common for networks using volumes to run either of the WINDOWS NT or WINDOWS 2000 types of operating systems. Neither WINDOWS NT nor WINDOWS 2000 provides a mechanism by which access to a volume can restricted to being read-only (here, the computer-context of mechanism is being used, which derives from the machine metaphor used in sciences concerned with man). Accordingly, in the SAN environment, it is known to restrict access to volumes via a proprietary file-system and server arrangement, i.e., restriction of access to a volume is carried out at the file level.

### SUMMARY OF THE INVENTION

At least one embodiment of the present invention provides a method of forestalling use of duplicate volume identifiers (volume-IDs), at least a portion of a volume being on a storage-device such that communication between an input/output (I/O) initiator and the storage-device takes place via a stack of device objects (DOs) representing the volume. Such a method may include: determining that a first volume-ID intended for a first volume is not available for use; and restricting access to the first volume by one of putting the first volume into a read-only-state in which access is restricted to read-only type access, and blocking I/O to the first volume.

Additional features and advantages of the invention will be more fully apparent from the following detailed description of example embodiments and the accompanying drawings.

### BRIEF DESCRIPTION OF THE DRAWINGS

The drawings are: intended to depict example embodiments of the invention and should not be interpreted to limit the scope thereof.

FIG. 1 is a software-architecture block diagram according to an embodiment of the invention.

FIG. 2 is a hardware block diagram according to an embodiment of the invention.

FIG. 3 is a hardware block diagram according to an embodiment of the invention.

FIG. 4A is a flowchart according to an embodiment of the invention.

FIG. 4B is a more detailed depiction of a portion of the flowchart of FIG. 4A, according to an embodiment of the invention.

FIG. 5A is a flowchart according to another embodiment of the invention.

FIG. 5B is a depiction of an alternative portion of the flowchart of FIG. 5A, according to an embodiment of the invention.

FIG. 5C is a more detailed depiction of a portion of the flowchart of FIG. 5A, according to an embodiment of the invention.

FIG. 6 is a flowchart according to another embodiment of the invention.

FIG. 7A is a flowchart according to another embodiment of the invention.

FIG. 7B is a more detailed depiction of a portion of the flowchart of FIG. 7A, according to an embodiment of the invention.

FIG. 8 is a software-architecture block diagram according to an embodiment of the present invention.

FIG. 9 is a software-architecture block diagram according to another embodiment of the present invention.

FIG. 10 is a UML-type sequence diagram according to an embodiment of the present invention. In a sequence diagram, → indicates an action that expects a response message. A [symbol] indicate a response message. A → indicates an action for which the response is implied. And a [symbol] indicates an action for which no response is expected.

FIG. 11 is a flowchart according to another embodiment of the invention.

FIGS. 12A and 12B are flowcharts according to another embodiment of the invention.

FIG. 13A is a flowchart according to another embodiment of the invention.

FIG. 13B is a more detailed depiction of a portion of the flowchart of FIG. 13A, according to an embodiment of the invention.

FIG. 14 is a state transition diagram according to an embodiment of the present invention.

FIG. 15 is a flowchart according to an embodiment of the present invention.

### DETAILED DESCRIPTION OF EXAMPLE EMBODIMENTS

In developing embodiments of the present invention, the following problems with the Background Art were recognized, the physics thereof determined, and the problem overcome. Implementing a mechanism (again, in the computer sense of the term mechanism) by which access to a volume is restrictable to being read-only at the volume-level, as opposed to the file level, would achieve benefits, e.g., better control, simpler implementation, etc. The Windows Driver Model (WDM) is a software architecture that can support such a volume-level mechanism, plus the WDM is compatible with WINDOWS NT and WINDOWS 2000. Thus, a volume-level read-only mechanism can be provided for either the WINDOWS NT or WINDOWS 2000 operating systems.

A disk is a random-access type of physical storage device such as a hard disk, a floppy diskette, or a CD-ROM or DVD, etc. A disk's hardware divides the disk into sectors, which are addressable blocks of fixed size. Sectors are grouped into partitions. A volume is a logical construct that represents a single partition or a group of partitions that a file-system manages as one unit. When a volume represents a group of partitions, they may exist on a single disk or be spanned across several disks and provide for data redundancy, fault tolerance, load balancing, or increase data through put. In the following discussion, for the sake of brevity, it is assumed that a volume corresponds to a single partition. Additionally, a volume can correspond to one or more tape drive storage units, upon which the same principles apply.

The WDM is a layered driver software architecture that is compatible with WINDOWS 98, (again) 2000, ME, XP and WINDOWS SERVER 2003. The WDM is a superset of the WINDOWS NT driver model (NTDM).

In a layered software architecture such as the WDM or NTDM, part of a communications path between a physically-connected device or a logical-unit (LUN) and an input/output (I/O) initiator (e.g., an application on a host connected to the device/LUN via a bus) is a stack of data structures, which in the WDM are referred to as device objects (DOs). Communication through such a stack primarily takes place via input/output request packets (IRPs) that are passed sequentially and successively between adjacent DOs either moving upward or downward in the stack.

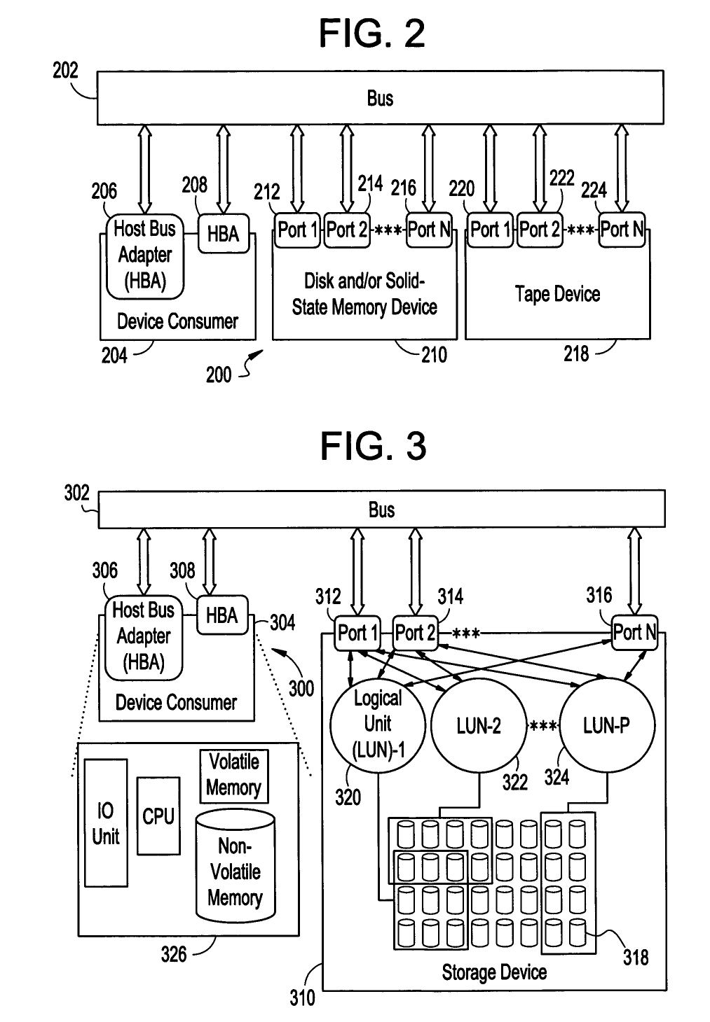

At initialization (in the WINDOWS environment), the plug-and-play (PnP) manager orchestrates the assembly of (also known as the adding of drivers to) a stack of drivers that handle the I/O for the storage-device by successively invoking drivers registered (in the registry of the host) to the type of storage-device, where each driver successively attaches a DO to the top of the stack. Some examples of storage-devices for which stack-building is facilitated according to embodiments of the invention are depicted in FIGS. 2-3 (to be discussed below).

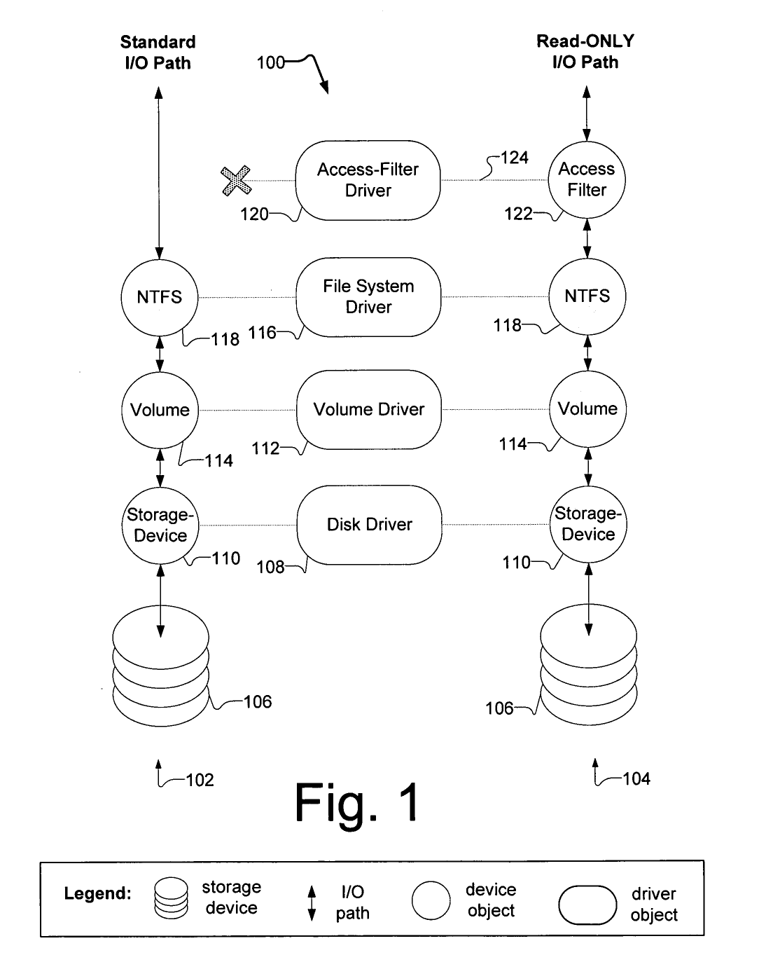

FIG. 1 is a software-architecture block diagram of a stack-building architecture 100 according to an embodiment of the invention, in particular according to an access-control type of filter driver according to an embodiment of the invention, e.g., 120 (to be discussed below). A filter driver, in general, monitors and/or modifies I/O request and/or provides value-added features. As will be discussed below in more detail, the operation of an access-filter device object (DO) (e.g., 122, to be discussed below) associated with an access-filter driver (e.g., as represented by a corresponding driver object 120) according to one of the embodiments of the invention can selectively establish read-only access to a volume of a storage-device (here, to continue the example, storage-device 106, which will be discussed below).

Architecture 100 is built-up in the memory of a host device, e.g., device consumer 204 (FIG. 2, to be discussed below). Architecture 100 can include a stack of device objects, namely a stack 104. Stack 104 corresponds to the physical storage-device 106, and can be similar in many ways to a standard I/0 path 102 for the storage-device (stack 102 being depicted here for contrast purposes). But stacks 102 and 104 differ, e.g., in that stack 104 has an access-filter device object 122 that has been added by access filter driver 120 (according to an embodiment of the invention), the association being indicated by dashed line 124.

Up to (but not including) access filter DO 122, stacks 102 and 104 can have the same arrangement, which includes: a physical DO (PDO) 110 forming the base of the stack that has been attached by a disk driver (as represented by the associated disk driver-object) 108; a volume-DO 114 attached to PDO 110, volume-DO 114 having been attached by a volume driver (as represented by the associated volume driver object) 112; and a file-system DO (FSDO) 118 attached to volume-DO 114, FSDO 118 having been attached by a file-system driver (as represented by the associated filter system driver object) 116. Access-filter driver 120 creates and attaches an associated access-filter DO 122 to stack 104 according to an embodiment of the invention. But (as shown by the large “X” in FIG. 1) access-filter driver 120 does not create and attach an access-filter DO 122 to stack 102.

A short discussion of hardware (in whose memory is built a stack such as stack 104), as depicted in FIGS. 2-3, follows. The hardware of FIGS. 2-3 represents example environments in which access-filter software and/or methods (according to embodiments of the invention) can be applied.

FIG. 2 depicts a hardware block diagram of a system 200, according to an embodiment of the invention, that incorporates software by which corresponding WDM-type stacks are built in memory. System 200 includes a bus (e.g., SCSI, Ethernet (iSCSI/IP/Gbit Ethernet), fibre channel, etc.) 202 to which is connected a host, which can be described as consumer of device services (hereafter a device consumer) 204, a storage-device 210 (e.g., a disk-based storage-device and/or a solid-state-based memory device) and a storage-device 218 (e.g., a tape-based storage-device). Stacks representing storage-devices 210 and 218 would be built-up in the memory (not shown) of device consumer 204. It is noted that HBAs 206 and 208 are additional devices for which stacks would be built in the memory of device consumer 204.

FIG. 3 depicts a hardware block diagram corresponding to a particular type of system 200, namely a storage area system or storage area network (SAN) 300. SAN 300 includes a bus 302, a device consumer 304 and a non-volatile storage-device 310. Device consumer 304 can include HBAs 306 and 308. Fewer or greater numbers of HBAs 306/308 can be provided depending upon the circumstances of a situation.

Device consumer 304 can take the form of a computer 326 including at least a CPU, input device(s), output device(s) and memory. For example, computer 326 has been depicted as including a CPU, an I/O unit, volatile memory such as RAM and non-volatile memory such as ROM, flash memory, disk drives and/or tape drives.

Storage-device 310 includes port 1 (312), port 2 (314), . . . port N (316) and logical units (LUNs) 1, 2, . . . P. A LUN can represent a type of massive non-volatile storage, which may have configuration functionality, monitoring functionality and/or mechanical functionality (such as tape changing), etc. Also included in storage-device 310 are non-volatile memories 318 such as disk drives, tape drives and/or solid-state memory.

More generally, embodiments of the invention can apply to any system having a host and a device (to which access is to be selectively restricted) connected together by a bus. Examples of such systems have been depicted in FIGS. 2 and 3, discussed above. Referring back to FIG. 1, storage-device 106 can correspond to devices 210, 218 and/or 310.

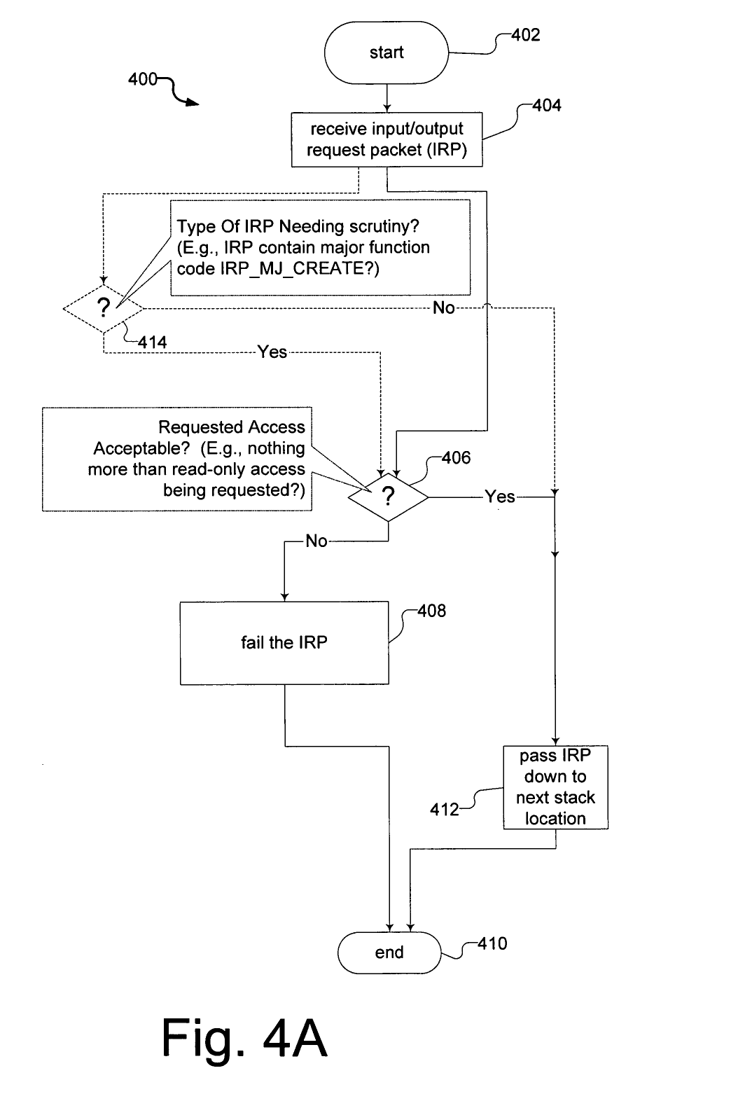

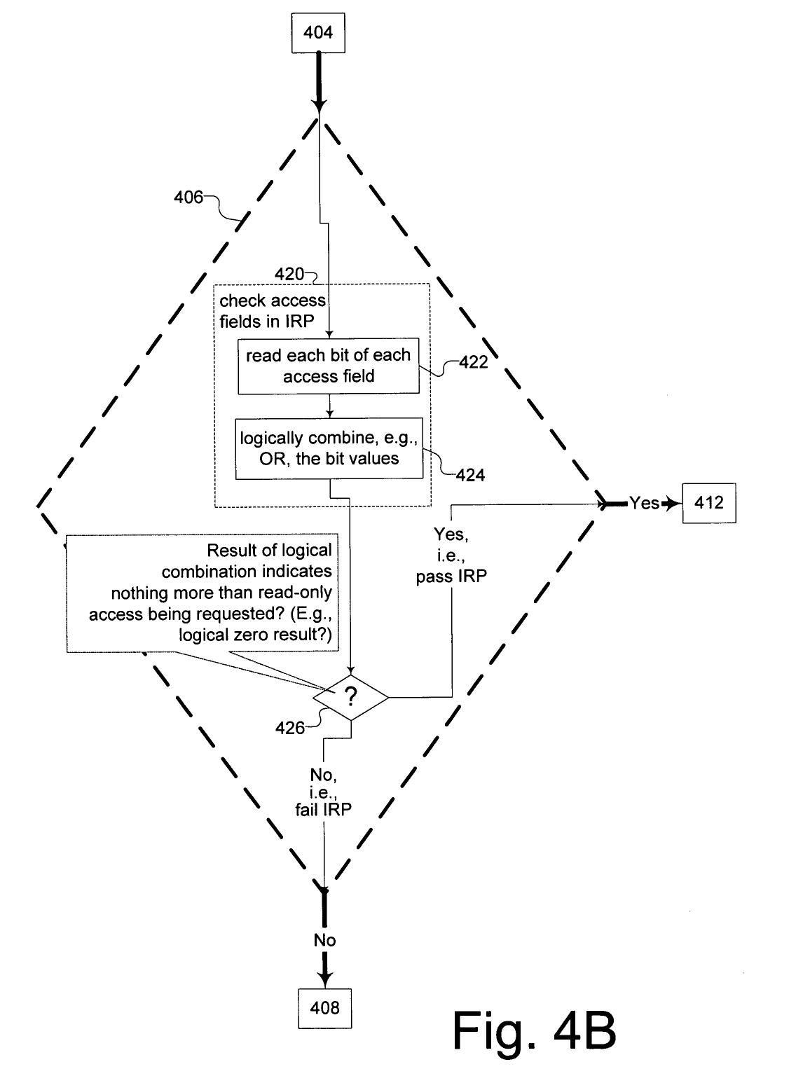

FIG. 4A depicts a flowchart 400 according to an embodiment of the invention by which an access-filter driver 120, via its associated access-filter DO 122, can selectively establish read-only access to a volume of storage-device 106 on the basis of the type of access being requested. Flowchart 400 begins at block 402 and flow proceeds to block 404, where access-filter DO 122 receives an input/output request packet (IRP). Flow proceeds to decision block 406, where access-filter driver 120 determines if the type of access to being requested by the IRP is acceptable. For example, where only a request for read-only access is acceptable, access-filter driver 120 can determine whether the IRP represents nothing more than a request for read-only access. If so (i.e., if yes), then flow proceeds to block 412, where access-filter driver 120 passes the IRP down to the next location in stack 104. Flow ends after block 410, as indicated by end block 410.

But if it is determined at decision block 406 of FIG. 4A that the requested access is not acceptable, e.g., that something more than read-only access has been requested, then flow proceeds to block 408, where access-filter driver 120 fails the IRP, e.g., using standard WDM procedures. Flow also ends after block 408, as indicated by end block 410.

Blocks 406 and 408 of FIG. 4A can be described as selectively establishing read-only access to a volume of storage-device 106 according to an embodiment of the invention.

There are optional aspects to flowchart 400 of FIG. 4A, as indicated by dashed lines. In particular, flow can optionally proceed to decision block 414, rather than directly to decision block 406. At decision block 414, access-filter river 120 can determine whether the IRP received at block 404 is of the type that needs scrutiny (on the basis of the major function code which the IRP contains) or can be passed along (e.g., flow can proceed directly to block 412, etc.). For example, access-filter driver 120 can inspect the IRP at decision block 414 for the presence of the particular major function code known as IRP_MJ_CREATE (as described in the driver development kit (DDK) of the WDM). If so (scrutiny merited because IRP_MJ_CREATE contained in IRP), then flow can proceed to decision block 406. But if not (scrutiny is not merited), then flow can proceed directly to block 412, etc. It is noted that decision block 414 can look for additional, or alternatively one or more other, major function codes.

Before returning to the discussion of FIG. 4A, it is noted (in general) that each IRP contains a major function code that tells a driver receiving the IRP what operation the receiving driver, or one of the drivers underlying the receiving driver in the stack, should carry out in order to satisfy the I/O request that the IRP represents. The major function code IRP_MJ_CREATE will be passed down a stack as a preliminary procedure in the circumstance that a protected subsystem (possibly on behalf of an application) requests a handle for the file object that represents the target device object underlying access-filter object 122 somewhere in stack 104, or a higher-level driver (overlying access-filter driver 120 in stack 104) is attempting to attach its associated object to stack 104.

An IRP containing the major function code IRP_MJ_CREATE also has one or more fields indicating the type of access that might be requested in a future IRP from the corresponding user-mode protected subsystem or a higher-level driver. In other words, an IRP containing the major function code IRP_MJ_CREATE is a precursor to a future IRP (which will represent a request for access to a volume) whose requested degree of access might be impermissible. An embodiment according to the invention, at least in part, is the recognition that failing such a precursor IRP (e.g., containing IRP_MJ_CREATE) in the circumstance in which it (the precursor IRP) portends a corresponding future impermissible-access IRP forestalls generation of the future impermissible-access IRP.

Returning to FIG. 4A, if the IRP is not of the type needing scrutiny, e.g., if the IRP does not contain the major function code IRP_MJ_CREATE (which, again, could portend future impermissible-access IRPs), then flow bypasses decision block 406 and proceeds to block 412, where the IRP is passed along. But if the IRP is of the type needing scrutiny, e.g., if the IRP contains IRP_MJ_CREATE, then flow proceeds to decision block 406, where it is further scrutinized (as discussed above).

FIG. 4B is a more detailed depiction of decision block 406 of the flowchart of FIG. 4A, according to an embodiment of the invention. Again, decision block 406 determines if the access being requested by the IRP is acceptable. FIG. 4B depicts an example of how that determination can be made by access-filter driver 120. Flow proceeds inside decision block 406 to block 420, where access-filter driver 120 checks one or more fields (each containing one or more bits) in the IRP that can be indicative of the type of access being requested. Where the IRP has the major function code IRP_MJ_CREATE (as defined in the DDK of the WDM), it can include one or more of the following fields, each of which is indicative of more than read-only access: FILE_WRITE_DATA; FILE_ADD_FILE; FILE_APPEND_DATA; FILE_ADD_SUBDIRECTORY; FILE_WRITE_EA; FILE_DELETE_CHILD; DELETE; WRITE_DAC; WRITE_OWNER; ACCESS_SYSTEM_SECURITY; GENERIC_WRITE; and FILE_WRITE_ATTRIBUTES.

In FIG. 4B, each of the one or more bits in the one or more access-indicative fields is read (block 422) and then logically combined (block 424), e.g., by logically ORing the bit values. Flow proceeds to decision block 426, where access-filter driver 120 determines whether the result of the logical combination indicates nothing more than read-only access is being requested. Where the logical combination is, e.g., the OR operation, then a result of zero would indicate nothing more than read-only access being requested. It is noted that other logical combinations can be used at block 424. If the logical combination of block 424 indicates that nothing more than read-only access is being requested, flow proceeds to block 412, where the IRP is passed along. But if block 424 indicates that something more than read-only access is being requested, then flow proceeds to block 408, where the IRP is failed.

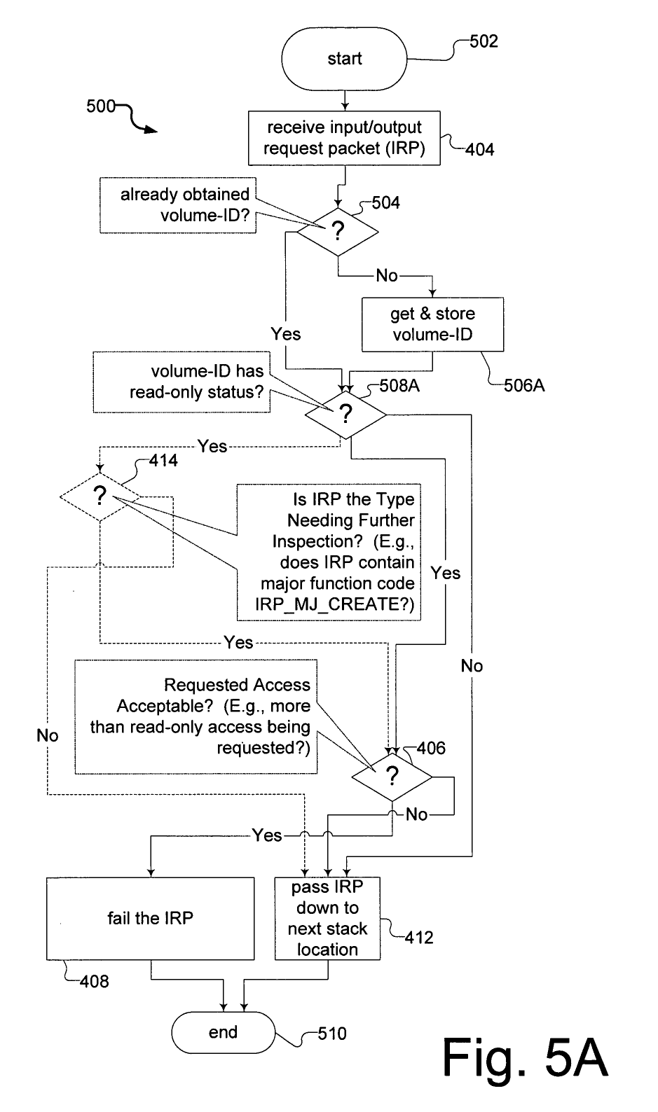

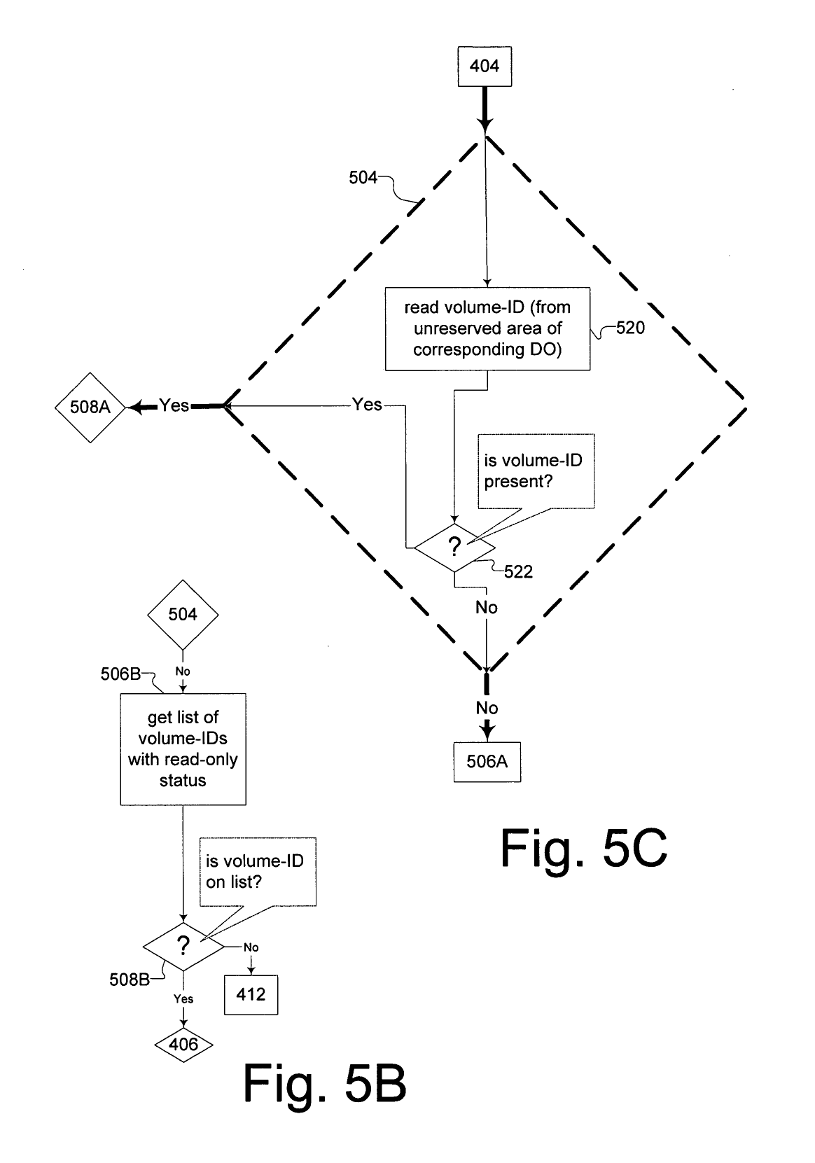

FIG. 5A depicts a flowchart 500 according to another embodiment of the invention by which an access-filter driver 120, via its associated access-filter DO 122, can selectively establish read-only access to a volume of storage-device 106 on the basis of not only the type of access being requested, but also the desired status of the volume to which access is being requested. Flowchart 500 has similarities to flowchart 400 of FIG. 4A which are reflected by the reuse of certain item numbers. Blocks in FIG. 5A (as well as other flowcharts to be discussed below) that are similar to those in preceding flowcharts will not be discussed in detail.

In flowchart 500 of FIG. 5A, flow starts at block 502 and proceeds via block 404 (reception of the IRP) to decision block 504. At decision block 504, access-filter driver 120 determines whether the volume identifier of the volume (to which the stack—of which access-filter DO 122 is a part—corresponds) is already known (has been obtained). A volume identifier (hereafter volume-ID) can be the name or label of the volume, or any other suitable identifier of the volume such as the underlying storage media's serial number, manufacture's name, connection type, media type, Globally Unique Identifier (GUID), corresponding disk and partition number, etc. Use of the volume label has an advantage of providing cross-platform, legacy, fault tolerant and simple volume support while providing a sufficiently unique volume-ID.

If the volume-ID is not yet known (as determined by decision block 504 of FIG. 5A), then flow proceeds to block 506A, where access-filter driver 120 obtains the volume-ID. From block 506A, flow proceeds to decision block 508A. If it is determined at block 504 that the volume-ID has already been obtained, then flow bypasses block 506A and proceeds directly to decision block 508A.

At decision block 508A in FIG. 5A, access-filter driver 120 determines whether the volume (to which the stack—of which the access-filter DO 122 is a part—corresponds) has read-only status based upon the volume-ID. If not, then it matters not what degree of access the IRP represents; so flow proceeds from the “NO” output of decision block 508A to block 412 (where the IRP is passed along), etc. But if the volume-ID has read-only status, then scrutiny of the IRP is merited; so flow proceeds from the “YES” output of decision block 508A to decision block 406 (to assess the whether a permissible degree of access is being requested), etc., or optionally to decision block 414 (to further determine if IRP scrutiny really is needed).

FIG. 5B depicts a portion of a flowchart representing an alternative to block 506A and decision block 508A of FIG. 5A. Flow would proceed from the “NO” output of decision block 504 to block 506B (an alternative to block 506A), where access-filter driver 120 obtains a list of volume-IDs having read-only status. Access-filter driver 120 does not necessarily update the list, rather it can simply read the list; an external application (e.g., the FibreNet3™ model of application made available by The Hewlett-Packard Company®), can be provided for creating, updating, and managing the list. From block 506B, flow proceeds to decision block 508B (an alternative to decision block 508A). At decision block 508B, access-filter driver 120 determines if the volume-ID indicated in the IRP is on the list. If not, then flow proceeds to block 412, etc. But if the volume-ID is on the list, then scrutiny of the IRP is merited; so flow can proceed to decision block 406 or optionally to decision block 414, etc.

FIG. 5C is a more detailed depiction of decision block 504 of the flowchart of FIG. 5A, according to an embodiment of the invention. Again, decision block 504 determines if the volume-ID has already been obtained. FIG. 5C depicts an example of how that determination can be made by access-filter driver 120. Flow proceeds inside decision block 504 to block 520, where access-filter driver 120 reads the value of the bits from an unreserved area of the IRP that represent the volume-ID. Flow proceeds to decision block 522, where access-filter driver 120 determines if the volume-ID bits are present; if so, that indicates that the volume-ID has already been obtained and flow is directed out of decision block 504 to decision block 508A. If it is determined at decision block 522 that the volume-ID has not yet been obtained (no bits are present), then flow is directed out of decision block 504 to block 506A.

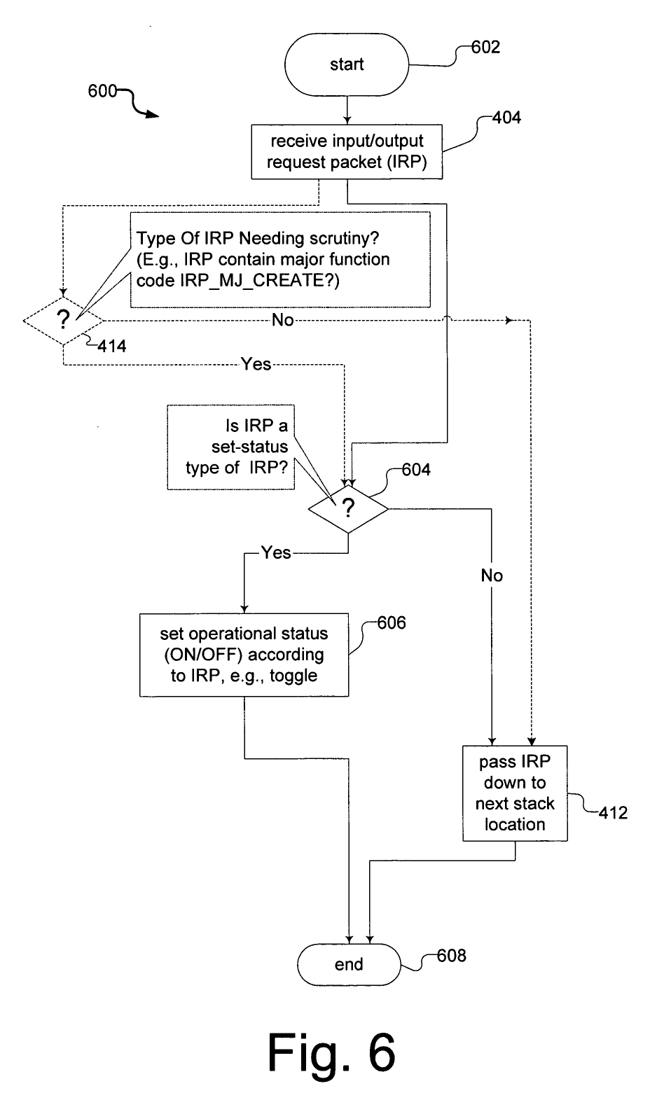

FIG. 6 depicts a flowchart 600 according to another embodiment of the invention by which an access-filter driver 120, via its associated access-filter DO 122, can selectively establish read-only access to a volume of storage-device 106 by selectively turning ON/OFF operation of access-filter driver 120, e.g., as it relates to monitoring the type of access being requested, etc. Flowchart 600 has similarities to preceding flowcharts; reused item numbers will not be discussed in detail.

In flowchart 600 of FIG. 6, flow starts at block 602 and proceeds via block 404 (reception of the IRP) to decision block 604. At decision block 604, access-filter driver 120 determines whether the IRP is of the type that sets the operational status of access-filter driver 120. Operational status is the desired read-state of the volume, e.g., read-only or read-write. For example, a bit (hereafter status_setter bit) in an unreserved area of the IRP can be used to indicate whether the IRP is a set-status IRP. If the IRP is not a set-status IRP (e.g., status_setter bit is not set), then flow proceeds to block 412 (where the IRP is passed along), etc.

But if the IRP is determined to be a set-status IRP at decision block 604 of FIG. 6, then flow proceeds to block 606, where access-filter driver 120 accordingly sets its operational status to ON or OFF, e.g., by toggling the operational status to the other read-state (e.g., if ON, then toggle to OFF, etc.). For example, a bit (hereafter op_status bit) in an unreserved area of the driver object representing access filter driver 120 can be set or vice-versa.

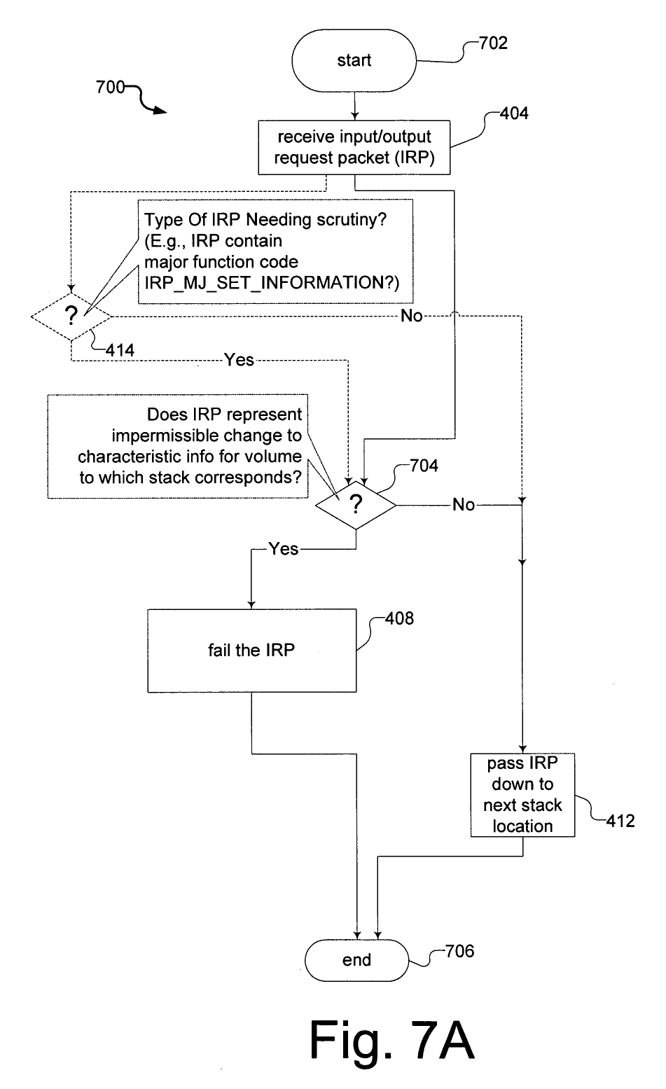

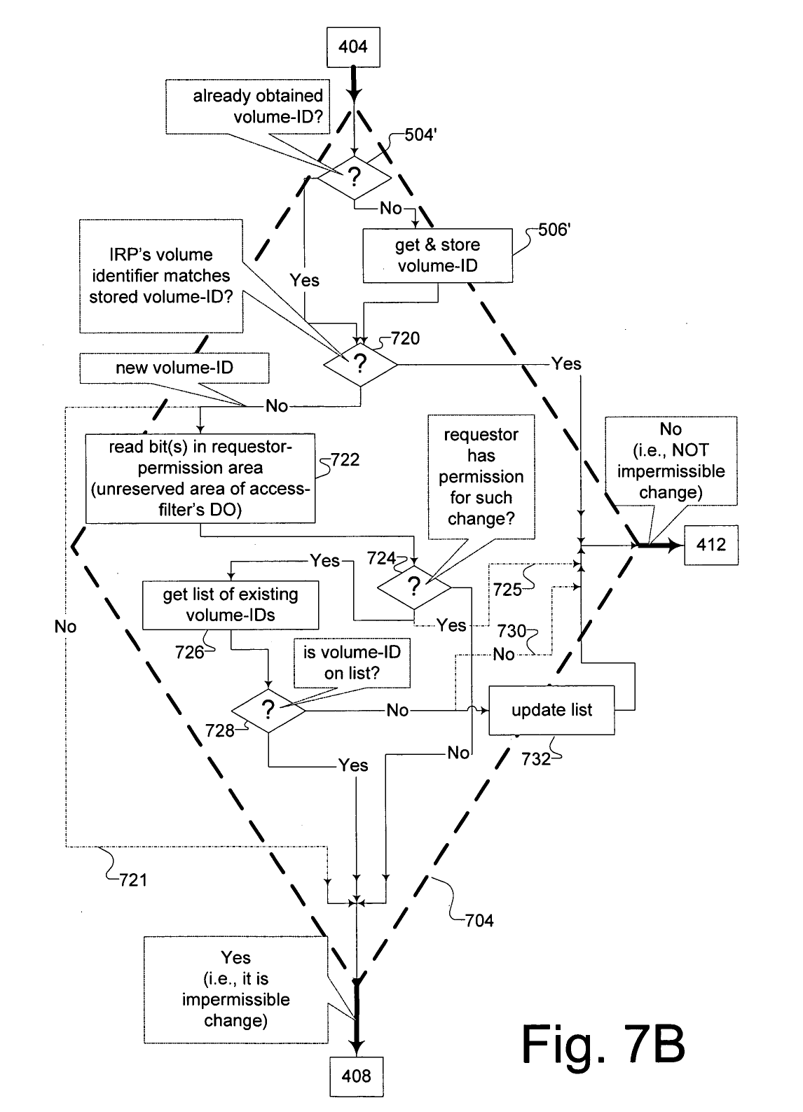

FIG. 7A depicts a flowchart 700 according to another embodiment of the invention by which an access-filter driver 120, via its associated access-filter DO 122, can prevent an attempt to defeat operation of access-filter driver 120 in its role of maintaining the volume in a read-only type of read-state or defeat the ability to later put a volume into a read-only type of read-state. Such prevention can be accomplished by selectively permitting changes (some but not all) to be made to the characteristic information for the volume to which stack 104 corresponds. Flowchart 700 has similarities to preceding flowcharts; reused item numbers will not be discussed in detail.

In flowchart 700 of FIG. 7A, flow starts at block 702 and proceeds via block 404 (reception of the IRP) to decision block 704, where access-filter driver 120 determines if the IRP represents an impermissible change to characteristic information for the volume to which stack 104 corresponds. If so, then flow proceeds to block 408 (where the IRP is failed), etc. If not (change is permissible), the flow proceeds to block 412 (where the IRP is passed along), etc.

FIG. 7B is a more detailed depiction of decision block 704 of the flowchart of FIG. 7A, according to an embodiment of the invention. Again, decision block 704 determines if the requested change in characteristic information for the volume is permissible. FIG. 7B depicts an example of how that determination can be made by access-filter driver 120. Flow proceeds inside decision block 704 to decision block 504, which is the same as decision block 504 except that it appears in FIG. 7B. It is determined at decision block 504′ whether the volume-ID has already been obtained. If not, then flow proceeds to block 506A′ (which similarly corresponds to block 506A), where the volume-ID is obtained. From block 506A′, flow proceeds to decision block 720. If it is determined at decision block 504′ that the volume-ID has already been obtained, then flow proceeds similarly to decision block 720.

At decision block 720 in FIG. 7B, access-filter driver 120 determines if the volume-ID in the IRP matches the stored volume-ID. If so, the change is permissible, and flow proceeds out of decision block 704 to block 412, etc. But if the volume-ID does not match, then it should be understood that the intent of the IRP is to change the volume-ID. Such a change would defeat the operation of certain of the access-filter driver embodiments according to the invention which filter/monitor according to the criterion of volume-ID because the volume-ID stored by access-filter DO 122 would no longer identify the volume to which stack 104 corresponds (and which access-filter driver 120 is intended to protect).

More particularly, at decision block 720, access-filter driver 120 checks one or more fields (each containing one or more bits) in the IRP that can be indicative of the type of access being requested. If it is determined at decision block 720 that the volume-ID in the IRP does match, then (optionally, as indicated by dashed line 721) flow can proceed directly to block 408 (where the IRP is failed), etc. Alternatively, further scrutiny of the IRP can take place, via flow proceeding to block 722. At block 722, access-filter driver 120 reads in one or more bits (representing an identifier of the entity having the requisite permission or a list of entities having the requisite permission) from a requestor-permission area (an unreserved area) in access-filter DO 122. Flow proceeds to decision block 724, where access-filter driver 120 determines if the requesting-entity identified by the IRP has the requisite permission by comparing it against the identifier/list obtained at block 722. If the requesting-entity has the requisite permission (if yes), then flow proceeds to block 408.

If it is determined at decision block 724 in FIG. 7B that the entity requesting the change in volume-ID does not have the requisite permission, then (optionally, as indicated by dashed line 725) flow can proceed directly to block 408 (where the IRP is failed), etc. Alternatively, further scrutiny of the IRP can take place, via flow proceeding to block 726. At block 726, access-filter driver 120 reads in a list of existing (currently in use) volume-IDs. Flow then proceeds to decision block 728.

In decision block 728 of FIG. 7B, access-filter driver 120 determines if the volume-ID is not currently being used, e.g., is not on the list. If not on the list, then the change is permissible, and flow then (optionally, as indicated by dashed line 730) can proceed directly to block 412 (where the IRP is passed along), etc. Alternatively, flow can proceed to block 412 via a block 732, where the list is updated to include the volume-ID in the IRP (that will become the new volume-ID of the volume).

When an operating system (OS) such as Windows NT or Windows®/2000 discovers that a volume is physically connected, several drivers create and attach various device objects to the stack through which I/O to/from the volume takes place. One such device object is the volume device object (again, DO). Merely because a device object for a volume-DO gets attached to the stack does not mean that the volume contains data that is organized by a file-system format that the OS currently recognizes.

Rather, a volume mount process should take place by which (1) the I/O manager of the OS identifies which file-system driver will be responsible for (or will be the owner of) the corresponding volume and (2) an associated file-system device object gets attached to the stack. Such a mount process can arise the first time the kernel of the OS, a device driver, or an application, etc. (hereafter, an I/O initiator) attempts to access a file or directory on a volume. After a file-system driver indicates its ownership for a volume, the I/O manager directs all IRPs aimed at the volume to the owning driver. The mount process includes three aspects: file-system driver registration, Volume Parameter Blocks (VPBs) processing, and mount requests.

The I/O manager oversees the mount process. All file-system drivers register with the I/O manager when they initialize. Hence, the I/O manager is aware of all available file-system drivers as a mount process begins.

A device object includes a VPB data structure, but the I/O manager treats the VPB as meaningful only for volume device objects. A VPB serves as a link between a volume device object and the file-system device object attached to the stack by the file-system driver that has claimed ownership of the file-system under which the volume is formatted. If the file-system reference field in a VPB is empty, then no file-system driver has mounted the volume. The I/O manager checks a volume device object's VPB whenever a command that specifies a filename or directory name on that volume device object is executed. At that point, if the VPB does not reference a file-system driver, then the I/O manager sequentially polls each registered file-system driver to ask if it recognizes the format of the volume in question as its own format. Once a file-system drive answers yes (or claims ownership), the polling stops.

File-system drivers are polled in last-registered first-called (LRFC) order (similar to last-in first-out or LIFO), so the most recently loaded file-system driver is the first one provided an opportunity to mount a volume. If no file-system driver recognizes/claims a volume, then a default file-system driver, e.g., RAW—a file-system driver built into Windows NT®—claims the volume and fails all requests to open files on the volume.

But if a file-system driver indicates affirmatively that it recognizes the format (or indicates ownership) of the volume in question as its own, then the file-system driver creates and attaches a corresponding file-system device object to the stack and the I/O manager fills in the appropriate field VPB (at which time the volume has become mounted), and then passes the open request to the file-system driver. The file-system driver completes the request (as well as subsequent I/O requests) by using its file-system format to interpret the data that the volume stores. After a mount process fills in the field of a volume device object's VPB, the I/O manager hands subsequent open requests aimed at the volume to the mounted file-system driver.

Not all mount-requests initially go to a file-system driver per se. A file-system recognizer (FSR) is a relatively smaller piece of code that masquerades as a regular file-system driver in the eyes of the I/O manager for the purpose of handling mount requests. A particular FSR creates a device object of the appropriate file-system type, registers it as a file-system with the I/O manager, and then waits to be polled via a mount-request. When an FSR recognizes a volume as being formatted under its corresponding file-system, it does not claim ownership (as would a file-system per se), rather it denies ownership, which causes the I/O manager to keep polling. Before the polling continues, however, the FSR interacts with the I/O manager to cause the corresponding full FSD to be loaded. As the corresponding full FSD is the most-recently registered, it is polled next in view of the LRFC polling sequence, and hence, the corresponding full FSD becomes the particular FSD that mounts the volume.

In developing embodiments of the present invention, the following problems with the Background Art were recognized, the physics thereof determined, and the problem overcome. According to the Background Art, access to a volume can (in effect) be blocked albeit at logical unit (LUN) level. The LUN-level is conceptually located below the volume-level. It can be desirable to control access to a volume at the volume-level, e.g., because this is more precise and/or direct than control at the LUN-level. Access at the volume-level could be blocked if the mounting of the volume could be prevented. Neither the Windows NT® nor Windows® 2000 type of operating system (OS) can prevent a volume having a recognizable file-system format (a file-system format that otherwise would be recognized and mounted by a registered FSR/FSD-combination or FSD per se) from being mounted. Rather, only access to a volume having an unrecognizable file-system format is blocked. But for the purposes of, e.g., controlling access to a volume at the volume-level, it would be desirable to have such a mount-prevention mechanism (be it selective or indiscriminate). Here, the term “mechanism” is used in the computer sense, which derives from the machine metaphor used in sciences concerned with man. Embodiments of the present invention provide such (selective and indiscriminate) mount-prevention mechanisms.

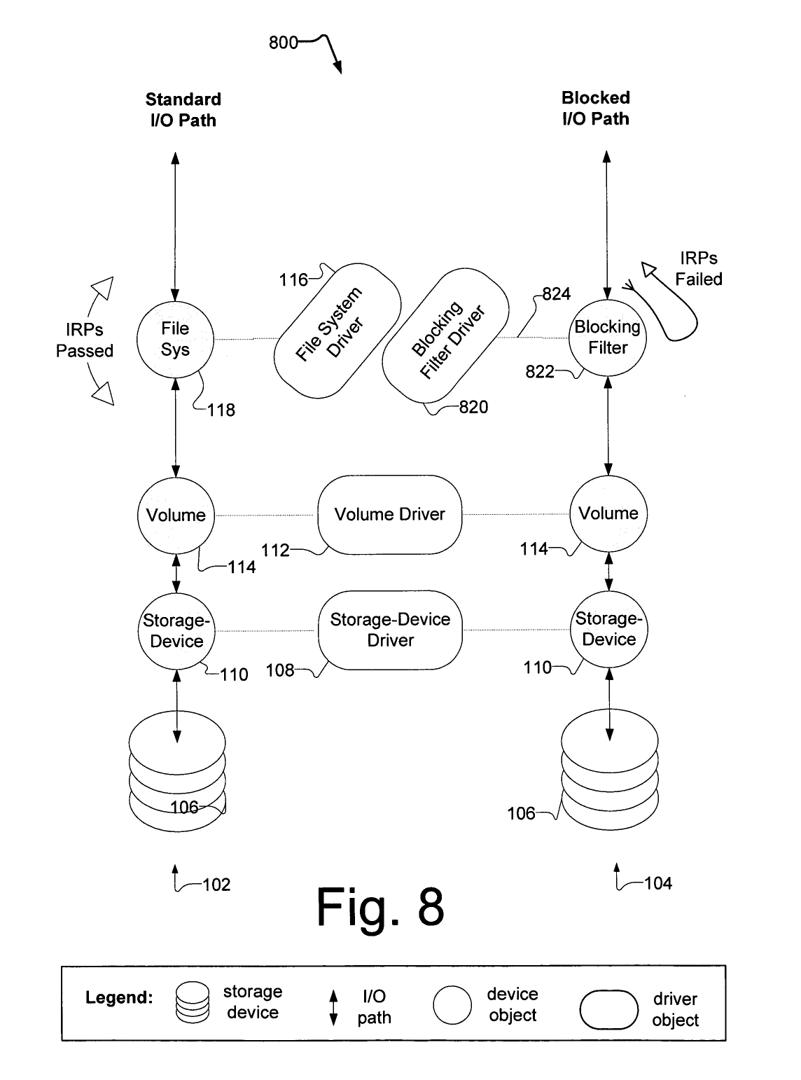

FIG. 8 is a software-architecture block diagram of a stack architecture by which mounting of a volume by a file-system driver is prevented (and thereby access to the volume is controlled) according to an embodiment of the present invention. It is noted that the hardware of FIGS. 2-3 represents example environments in which volume-mount-preventing software and/or methods (according to embodiments of the present invention) can be applied.

In FIG. 8, a volume-mount-preventing stack architecture 800 according to an embodiment of the present invention includes a blocking filter driver 820 (itself according to an embodiment of the present invention, to be discussed below). A filter driver, in general, monitors and/or modifies I/O requests and/or provides value-added features. As will be elaborated upon below, the operation of a device object (DO) 822 (also discussed in more detail below) associated with blocking filter driver 820 can prevent an otherwise corresponding file-system driver from mounting a volume.

Architecture 800 is built-up in the memory of a host device, e.g., device consumer 204 (see FIG. 2, as discussed below). Architecture 800 can include a stack 104 of device objects. Stack 104 corresponds to a physical storage-device 106 (e.g., a disk or tape drive), and can be similar in many ways to a standard I/O stack 102 for device 106 (stack 102 being depicted here for contrast purposes). But stacks 102 and 104 differ, e.g., in that stack 104 has blocking-filter DO 822 that has been added by blocking filter driver 820 (according to an embodiment of the present invention), the association being indicated by dashed line 824.

A state in which stack 102 exists can be described as an I/O state in which file-system driver 116 is permitted to mount the volume represented by volume-DO 114, hereafter described as a permitted-state. A state in which stack 104 exists can be described as an I/O state in which file-system driver 116 is prevented from mounting the volume represented by volume-DO 114, hereafter described as a prevented-state.

Up to (but not including) blocking-filter DO 822, stacks 102 and 104 can have the same arrangement, which includes: a physical DO (PDO) 110 that forms the base of the stack and that has been generated by a storage-device driver (which is represented in FIG. 8 via depiction of the associated storage-device driver-object) 108; and a volume DO 114 attached to PDO 110 by a volume driver (which is represented in FIG. 8 via the depiction of the associated volume driver object) 112.

FIG. 8 has been simplified in some respects. Not only is a PDO 110 created, but also one or more partition device objects. The chain of attachment from storage-device DO 110 to volume DO 114 differs depending upon whether the OS is Windows NT® or Windows® 2000. Windows NT® attaches volume DO 114 to storage-device DO 110, with the one or more partition DOs located (conceptually) at a same level in stack 102/104 as (hereafter, adjacent to) storage-device DO 110, and storage-device driver 108 manages IRPs in view of relationships between the adjacent partition-DOs and storage-device DO 110. In contrast, Windows® 2000 attaches volume-DO 114 to one or more partition-DOs adjacent to storage-device DO 110, and attaches the one or more partition-DOs to storage-device DO 110. For the purposes of the present discussion, both Windows NT® or Windows® 2000, in effect, attach volume-DO 114 to storage-device DO 110. Hence, partition-DOs are not depicted in FIG. 8, for simplicity.

Preferably, blocking filter driver 820 is not one of the drivers typically registered with an OS, hence no blocking DO is present in typical stack 102. For the typical circumstance of stack 102, it is assumed that the first registered file-system driver to recognize the file-system of the corresponding volume on disk 106 is file-system driver 116 (which is represented in FIG. 8 via depiction of the associated driver object). File-system driver 116 attaches a corresponding file-system device object (hereafter file-sys DO) 118 to stack 102.

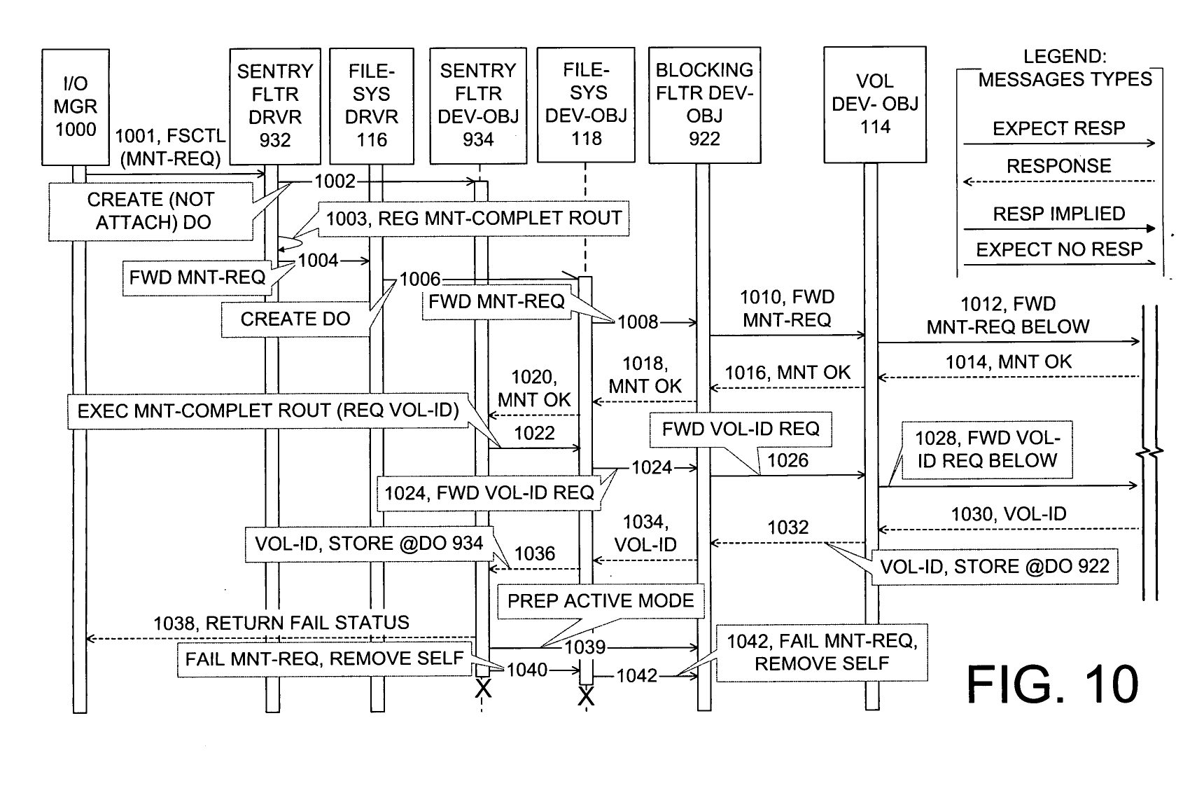

Blocking filter driver 820, however, is among the drivers registered with the OS. Blocking filter driver 820 poses as a file-system driver as far as the I/O manager (which is depicted in FIG. 10 and hereafter is I/O manager 1000) is concerned, which includes indicating to I/O manager 1000 that it recognizes the file-system of the corresponding volume on disk 106 and attaching an associated blocking-filter DO 822 to stack 104. In doing so, blocking filter driver 820 prevents the registered file-system driver that corresponds to the actual file-system format of storage-device 106 (e.g., corresponding to file-system driver 116) from claiming ownership of volume 114 and attaching its associated file-sys DO 118.

To successfully pose as file-system driver 116 (recall that file-system driver 116 is assumed to correspond to the file-format of storage-device 106), blocking filter driver 820 needs to be polled as to ownership before the FSR for file-system driver 116 (or file-system 116 itself if no corresponding FSR is being used) is polled. In light of I/O manager 1000 polling (as to ownership) in last-registered first-called (again, LRFC) order, blocking filter driver 820 needs to be loaded after the FSR for file-system driver 116. Such post-FSR loading can be arranged via an installation script corresponding to blocking filter driver 820.

The installation script can ensure post-FSR loading in different ways. In the following discussion, it is assumed that any file-system driver for which blocking filter driver 820 is to be a poseur has its FSR loaded at boot-start (and is correspondingly marked as SERVICE_SYSTEM_START) as opposed to system-start (and corresponding marking as SERVICE_BOOT_START). If not, the following discussion can be adapted accordingly to preserve post-FSR loading.

For example, in addition to registering the blocking with the OS (which sets information in the system registry indicating that the blocking filter driver 820 is a file-system driver), the installation script can edit an entry in the registry known as ServiceGroupOrder to add a new group name, e.g., “blocking”, after the group name “file-system”.

Table 1 (below) shows typical contents of ServiceGroupOrder before running the installation script, and Table 2 (below) shows ServiceGroupOrder after running the installation script. Group name blocking has been added to Table 2 as contrasted with Table 1.

TABLE 1

SCSI miniport
port
Primary disk
SCSI class
SCSI CDROM class
filter
boot file-system
Base
Pointer Port
Keyboard Port
Pointer Class
Keyboard Class
Video Init
Video
Video Save
file-system
Event log
Streams Drivers
NDIS
TDI
NetBIOSGroup
SpoolerGroup

TABLE 2

SCSI miniport
port
Primary disk
SCSI class
SCSI CDROM class
filter
boot file-system
Base
Pointer Port
Keyboard Port
Pointer Class
Keyboard Class
Video Init
Video
Video Save
file-system
blocking
Event log
Streams Drivers
NDIS
TDI
NetBIOSGroup
SpoolerGroup

Correspondingly, the installation script sets a registry entry for blocking filter driver 820 to be, e.g., “Group=blocking”.

Alternatively, the installation script can put blocking filter driver 820 in the group named file-system and use an optional key known as “tag” in the respective driver's registries to ensure post-FSR loading. The installation script can then appropriately manipulate the sequence of Tag values in GroupOrderList so that the Tag value for blocking filter driver 820 comes after the Tag value for the FSR for file-system driver 116 in the sequence of Tag values. Further in the alternative, an optional key known as “DependOnGroup” can be correspondingly manipulated.

After the installation script runs, blocking filter driver 820 is not loaded until the host is rebooted. After reboot, blocking filter driver 820 is loaded and registered with I/O manager 1000 after any FSR associated with a file-system driver for which blocking filter driver 820 is to be a poseur. Hence, when I/O manager 1000 begins polling as to ownership of the file-format of storage-device 106, blocking filter driver 820 is the first driver polled by I/O manager 1000 via a mount request. After blocking filter driver 820 answers I/O manager 1000 by indicating it recognizes the file-format of storage-device 106, then I/O manager 1000 fills in the field of the volume parameter block (again, VPB) and blocking 820 attaches blocking-filter DO 822 to stack 106.

Subsequently, when an IRP traversing down stack 106 reaches blocking-filter DO 822, blocking filter driver 820 fails the IRP and returns it to I/O manager 1000. To the I/O initiator (or to a user thereof), the effect is as if volume 114 is hidden from the view of the I/O initiator. In other words, IRP traversal past blocking-filter DO 822 is blocked, which effectively controls access to the volume represented by volume DO 114.

It is noted (in general) that each IRP contains a major function code that tells a driver receiving the IRP what operation the receiving driver, or one of the drivers underlying the receiving driver in the stack, should carry out in order to satisfy the I/O request that the IRP represents.

An IRP containing major function code IRP_MJ_CREATE will be passed down a stack as a preliminary procedure in the circumstance that an I/O initiator attempts to access a file or directory on the volume represented by volume DO 114. As such, the IRP containing major function code IRP_MJ_CREATE is a precursor to a future IRP (which will represent a request for access to a storage volume). Failing such a precursor IRP (e.g., containing IRP_MJ_CREATE) will typically forestall such related future IRPs. However, each attempt by an I/O initiator to access a file or directory on the volume represented by volume DO 114 will typically result in a new instance of an IRP_MJ_CREATE-containing IRP traversing down stack 106 to blocking DO 118.

The mount-prevention mechanism according to embodiments of the invention described in terms of FIG. 8 is not inherently selective in the sense of being able to choose which volume to prevent from being mounted versus which volume to permit mounting. It is useful to have a selective mount-prevention mechanism.

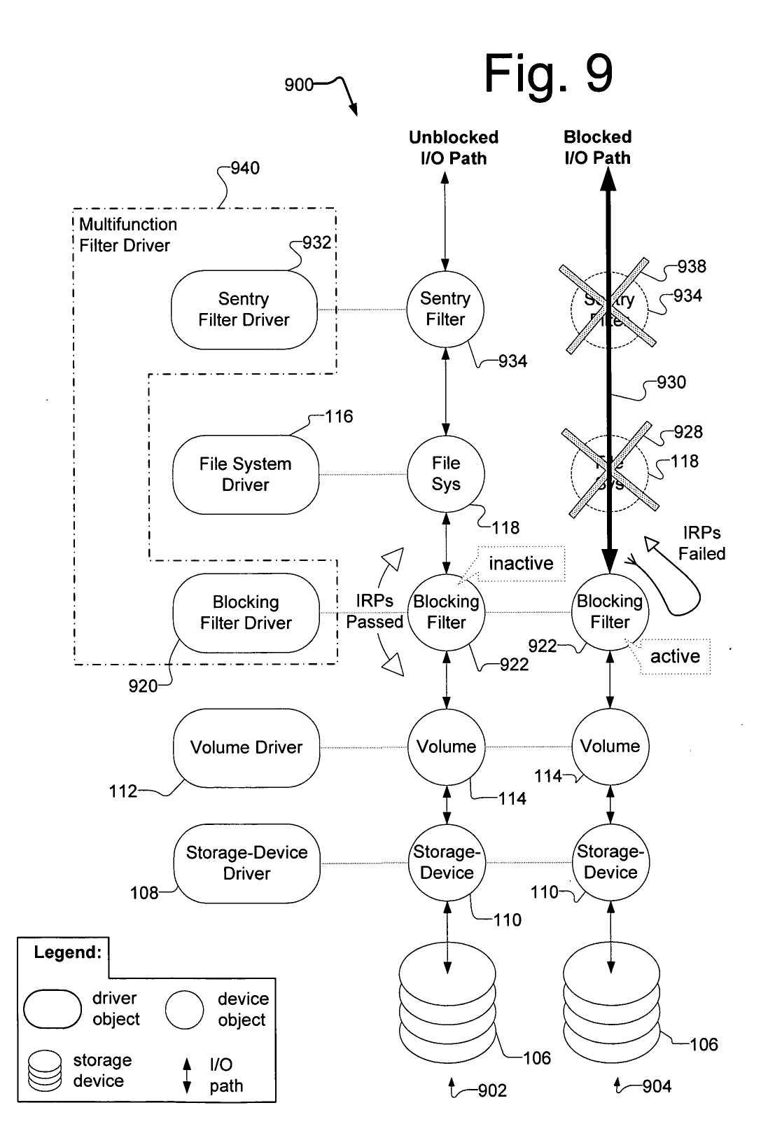

FIG. 9 is a software-architecture block diagram of a stack architecture by which mounting of a volume by a file-system driver is selectively prevented (and thereby selective access to the volume is controlled) according to an embodiment of the present invention. Some examples of devices for which a selective volume-mount-preventing stack is constructed are depicted in FIGS. 2-3 (discussed above).

In FIG. 9, a selective volume-mount-preventing stack architecture 900 according to an embodiment of the present invention includes a blocking filter driver 920 (itself according to an embodiment of the present invention, to be discussed below). As will be elaborated upon below, the operation of a blocking filter device object (DO) 922 (also discussed in more detail below) associated with blocking filter driver 920 can selectively prevent a file-system driver from mounting a volume.

Some of same or similar components in stack architecture 100 are found in stack architecture 900, which is reflected in the use of the same or similar item numbers, respectively. For example, blocking filter driver 920 (to be discussed below) in FIG. 9 is similar to blocking filter driver 820 in FIG. 8. Discussion of the same or similar items will be minimal, for the sake of brevity.

Stack architecture 900 is built-up in the memory of a host device, e.g., device consumer 204 (see FIG. 2, as discussed above). Architecture 900 can include a stack 902 or a stack 904 of device objects. Stacks 902 and 904 are alternative stacks that correspond to physical storage-device 106 but which include different device objects based upon whether the mode of blocking filter driver is inactive or active. Stacks 902 and 904 differ in that stack 902 includes a file-sys DO 118, whereas stack 904 does not (which is indicated by file-sys DO 918 being depicted via dashed lines with a large superimposed “X’ 928).

Up to (and including) blocking-filter DO 822, stacks 902 and 904 can have the same arrangement, which includes: PDO 110; volume DO 114; and blocking-filter DO 922. FIG. 9 has been simplified similarly to FIG. 8.

In stack 902, blocking-filter DO 922 is depicted as being in an inactive mode. In contrast, in stack 904, blocking-filter DO 922 is depicted as being in an active mode. Also, stack 902 includes: file-sys DO 118 attached to inactive blocking-filter DO 922; and sentry filter DO 934 attached to file-sys DO 118 by a filter driver (hereafter sentry filter driver) associated with file-system driver 118 (which is represented in FIG. 9 via the depiction of the associated volume driver object) 932. As noted, stack 904 does not include file-sys DO 118. Nor does stack 904 include sentry filter DO 934.

Operating together, sentry filter driver 932 and blocking filter driver 920 achieve a selective mount-prevention mechanism according to an embodiment of the present invention. As with blocking filter driver 820, blocking filter driver 920 is registered after the FSRs for the typical file-system drivers. It is assumed again that file-system driver 116 corresponds to the file-system under which the volume (represented by volume DO 114) is formatted. Accordingly, I/O manager polls blocking filter driver 920 first via a mount-request, as mentioned above. A mount request is carried out via a type of file system control code (FSCTL).

The building up and tearing down of stack 902 will now be discussed in more detail. The volume-manager begins polling file-system drivers in LRFC order to determine which file-system driver owns the volume. I/O manager 1000 begins polling drivers in LRFC order,

As a driver-poseur that is arranged to be loaded after the other file-system drivers, the mount request (hereafter mount FSCTL) is sent first to blocking (and file-system-driver-posing) filter driver 920. In response to the mount FSCTL, blocking filter driver 920 creates and attaches its blocking-filter DO 922 to stack 902 and initially sets the value of one or more mode bits (representing the state, active/inactive) of blocking filter driver 920 in an unreserved area of blocking-filter DO 922 to put itself into inactive mode. As part of inactive mode, blocking-filter DO 922 indicates to I/O manager 1000 that it is not the owner of volume DO 114. So I/O manager 1000 continues polling file-system drivers. It is assumed that the next file-system driver to be polled is file-system driver 116, which (again) here is assumed to be the owner of the volume.

The building up and tearing down of stack 902 will now be discussed in more detail in terms of FIG. 10, which is a sequence diagram according to an embodiment of the present invention. In FIG. 10, I/O manager 1000 attempts to send a mount FSCTL to file-system driver 116. But sentry filter driver 932 is arranged in relation to each file-system driver so as to be able to intercept a mount FSCTL bound for the file-system driver. Accordingly, sentry filter driver 932 intercepts the mount FSCTL, as indicated by arrow 1001 going to sentry filter driver 932 instead of file-system driver 116. As indicated by arrow 1002, sentry filter driver 932 creates a device object, namely sentry DO 934, but does not yet attach sentry DO to another DO on stack 902. At arrow 1003, sentry filter driver 932 registers a mount-completion routine in the mount FSCTL, which will return control of the mount FSCTL to sentry filter driver 932 when the mount FSCTL is otherwise complete. At arrow 1004, sentry filter driver 932 forwards the mount-request to file-system driver 116. 1001041 At arrow 1007 of FIG. 10, file-system driver 116 creates and attaches its device object, namely file-sys DO 118. At arrow 1008, the mount-request is forwarded from file-sys DO 118 to blocking DO 922. At arrow 1010, the mount-request is forwarded volume-DO 115. At arrow 1012, the mount-request is forwarded to a DO below volume-DO 115 in stack 902. Arrow 1014 is the response, from below in stack 902, indicting a successful mount-request; otherwise described indicating the mount as being okay. At arrow 1016, the mount-okay indication is forwarded to blocking filter DO 922. At arrow 1018, the mount-okay indication is forwarded to file-sys DO 118. Then at arrow 1020, the mount-okay indication is forwarded to sentry filter DO 934.

At arrow 1022, sentry filter driver 932 generate and sends via sentry filter DO 343 an IRP down stack 902 requesting the volume-ID. A volume-ID can be the label or name of the volume. Alternatively, the volume-ID can be any other suitable identifier of the storage volume such as the underlying storage media's serial number, manufacture's name, connection type, media type, Globally Unique Identifier (GUID), corresponding disk and partition number, etc. Use of the volume label has an advantage, e.g., of providing cross-platform, legacy, fault tolerant and simple volume support while providing a sufficiently unique identifier.

The IRP of arrow 1022 first goes to file-sys DO 118, and then is successively forwarded down the stack, as indicated by arrows 1024 (IRP pausing at blocking filter DO 922), 1026 (IRP pausing at volume-DO 114) and 1028. Arrow 1028 represents the IRP being forwarded further down in stack 902 where it will be serviced in a well known manner. Arrow 1030 is the response to the IRP, namely the volume-ID, returning from somewhere below in stack 902 and initially reaching volume-DO 114. The volume-ID is then forwarded up stack 902, as indicated by arrows 1032 (pausing at blocking filter DO 922), 1034 (pausing at file-sys DO 118) and 1036 (where it reaches sentry filter DO 934). It is noted that the volume-ID is stored in unreserved areas of blocking filter DO 922 and sentry filter DO 934 as part of arrows 1032 and 1036.

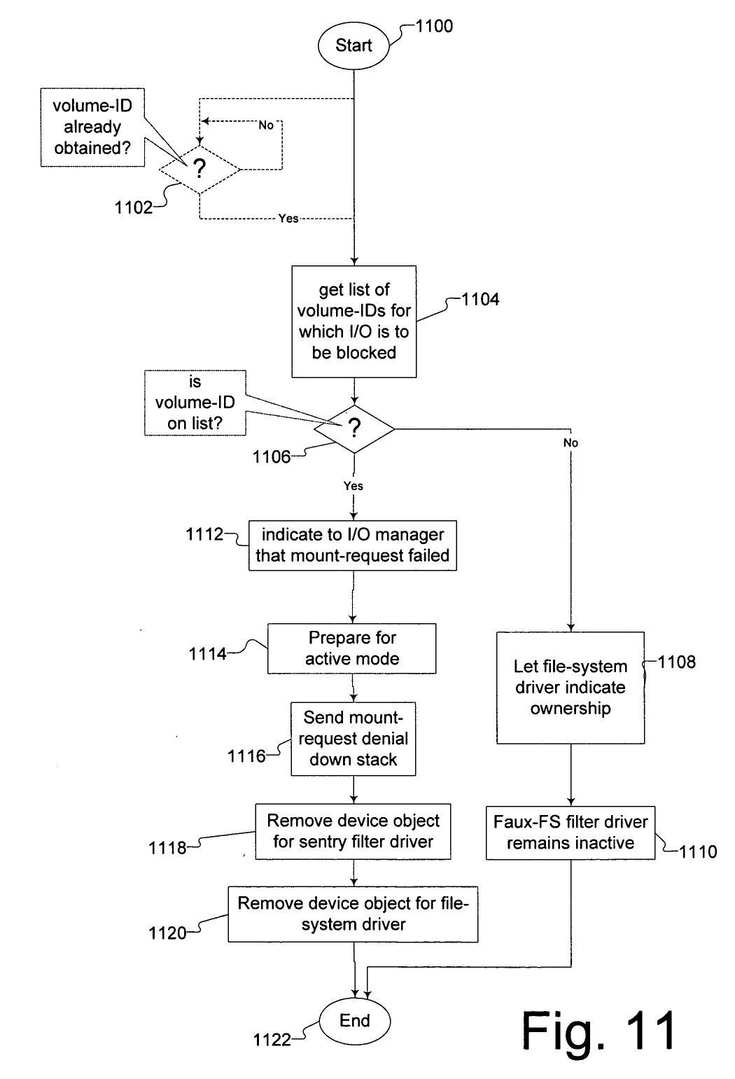

Discussion now will include the flowchart of FIG. 11, according to an embodiment of the present invention, which can take place after arrow 1036 of FIG. 10. After sentry filter driver 932 receives the volume-ID, flow begins in flowchart begins at block 1100 and proceeds to block 1104, where sentry filter driver 932 obtains a list of volume-IDs for which I/O is to be blocked. The list can be stored/updated/managed, etc., by sentry filter driver 932 itself, or an external application (e.g., the FibreNet3™ model of application made available by The Hewlett-Packard Company®) can be provided for creating, updating, and managing the list in which case sentry filter driver 932 merely reads the list. Here it is assumed that the list is provided by an external application.

From block 1104, flow proceeds to decision block 1106, where sentry filter driver 932 determines if the volume-ID corresponding to volume DO 114 is on the list. If not, then blocking filter driver 920 will remain in the inactive mode, as represented by flow proceeding to block 1108, where sentry filter driver 932 forwards the completion-status (successful) indication to I/O manager 1000, which then sets file-system driver 116 as the owner in the appropriate field of the VPB. Again, in the inactive mode, blocking filter driver 920 (via blocking-filter DO 922) merely passes along IRPs that come down stack 902 instead of failing them.

But if it is determined at decision block 1106 that the volume-ID corresponding to volume DO 114 is on the list of volumes to which I/O is to be blocked, then sentry filter driver 932 does not forward the successful completion-status indication up stack 902 to I/O manager 1000. Instead, flow proceeds to block 1112, where sentry filter driver 932 returns a failure completion-status to I/O manager 1000. This is also indicated in the sequence diagram of FIG. 10 by arrow 1038, the indication being communicated via sentry filter DO 934. This interrupts the process that represents the mount-request. Such interruption is represented by flow proceeding to block 1114, where sentry filter driver switches blocking filter driver into active mode by appropriately setting the value of the one or more mode bits in the unreserved area of the device object for blocking-filter DO 922. This is also indicated in FIG. 10 as arrow 1039.

Then flow proceeds to block 1116, where sentry filter driver 932 sends a mount-request-denied completion-status down stack 902. Then flow proceeds to block 1118, where sentry filter driver 932 removes its sentry filter DO 934 (in other words, itself) from stack 902. Blocks 1116 and 1118 correspond to arrow 1040 of FIG. 10. Then flow proceeds to block 1102, where file-system driver 116 forwards the mount-request-denied completion-status down stack 902 and responds thereto by removing its file-sys DO 118 (in other words, itself) from stack 902, which corresponds to arrow 1042 in FIG. 10.

Alternatively, the flowchart of FIG. 11 can be entered under different circumstances. If so, then alternatively (as indicated by dashed lines) flow can proceed from starting block 1100 to optional (as indicated by dashed lines) decision block 1102, where sentry filter driver 932 can determine if the volume-ID has already been obtained. If not, sentry filter driver 932 can wait at block 1102 until the volume-ID has been obtained. Once obtained, flow can proceed to block 1104, etc.

Blocking filter driver 920 receives, via blocking filter DO 922, the mount-request-denied completion-status, checks its mode bits, which now indicate active mode. Accordingly, blocking filter driver 920 does not remove its blocking filter DO 922, e.g., because blocking filter DO 922 can be reused.

After receiving the failure completion-status (see arrow 1038), I/O manager 1000 continues attempting to determine ownership of the volume by polling the next file-system driver in the sequence with a mount FSCTL. But sentry filter driver 932 intercepts the mount FSCTL bound for the next file-system driver. Sentry filter driver 932 then forwards the mount-request to blocking filter driver 920. Blocking filter driver answers the mount FSCTL by indicating that it owns the volume (again, represented by volume-DO 114). At this point, the stack is no longer represented by stack 902, but is now represented by stack 904. In contrast to the building of corresponding stack 104, where blocking filter driver 820 had to attach blocking filter DO 822, blocking filter DO 922 already exists, hence the building of stack 904 reuses blocking filter DO 922. At this point, the remainder of stack 906 is constructed in the same manner as the corresponding portion of stack 104. As a result, file-system driver 116 will not attach its file-sys DO 118 (which is depicted suitably in dashed lines with a superimposed “X” 928), nor will sentry filter driver 932 attach its sentry filter DO 934 (which is depicted suitably in dashed lines with a superimposed “X” 938). Accordingly, path segment 930 of stack 904 is superimposed on items 118, 928, 934 and 938. Like blocking filter driver 820, an IRP traversing down stack 106 that reaches blocking filter driver 920 in its active mode will be failed and returned to I/O manager 1000. To the I/O initiator (or to a user thereof), the effect (similarly) is as if volume 114 is hidden from the view of the I/O initiator. In other words, IRP traversal past blocking-filter DO 922 is blocked, which effectively controls access to the volume represented by volume DO 114.

For simplicity of explanation, the selective mount-prevention mechanism described above has treated sentry filter driver 324 and blocking filter driver 920 as being separate filter drivers. Alternatively, they can be combined into a single multifunction driver, as indicated by item 940. Such a multifunctional driver implementation is advantageous, e.g., because communication between functional units (corresponding to drivers 932 and 920) is simplified.

The selective mount-prevention mechanism according to embodiments of the invention described above in terms of FIG. 9 is not dynamically switchable between inactive and active mode of blocking filter driver 920 after the volume has been mounted. It can be desirable to have a dynamically switchable mount-prevention mechanism that can be switched from being engaged to being disengaged as well as switched from being disengaged to being engaged. As will be elaborated upon below, the combined operation of a dynamically switchable version of sentry filter driver 932 (according to another embodiment of the present invention) and blocking filter driver 920 can dynamically switch blocking filter driver 920 from inactive to active mode, and from active to inactive mode, in order words switch from stack 902 (representing a permitted-state) to stack 904 (representing a prevented-state) and vice-versa.

As mentioned above, an IRP containing major function code IRP_MJ_CREATE will be passed down a stack as a preliminary procedure in the circumstance that an I/O initiator attempts to access a file or directory on the volume represented. SENTRY filter driver 932, via its SENTRY DO 934, can check each IRP_MJ_CREATE-containing IRP for the presence of a mode-switching (MS) control-code. The MS control-code determines the mode into which blocking filter driver 920 is to be put.

If the MS control-code is present, SENTRY filter driver 932 can determine if the indicated mode is different than the present mode of blocking 920. If so, then SENTRY filter driver 932 can cause an incomplete tearing-down and subsequent rebuilding of the stack (changing from stack 902 to stack 904 or vice-versa).

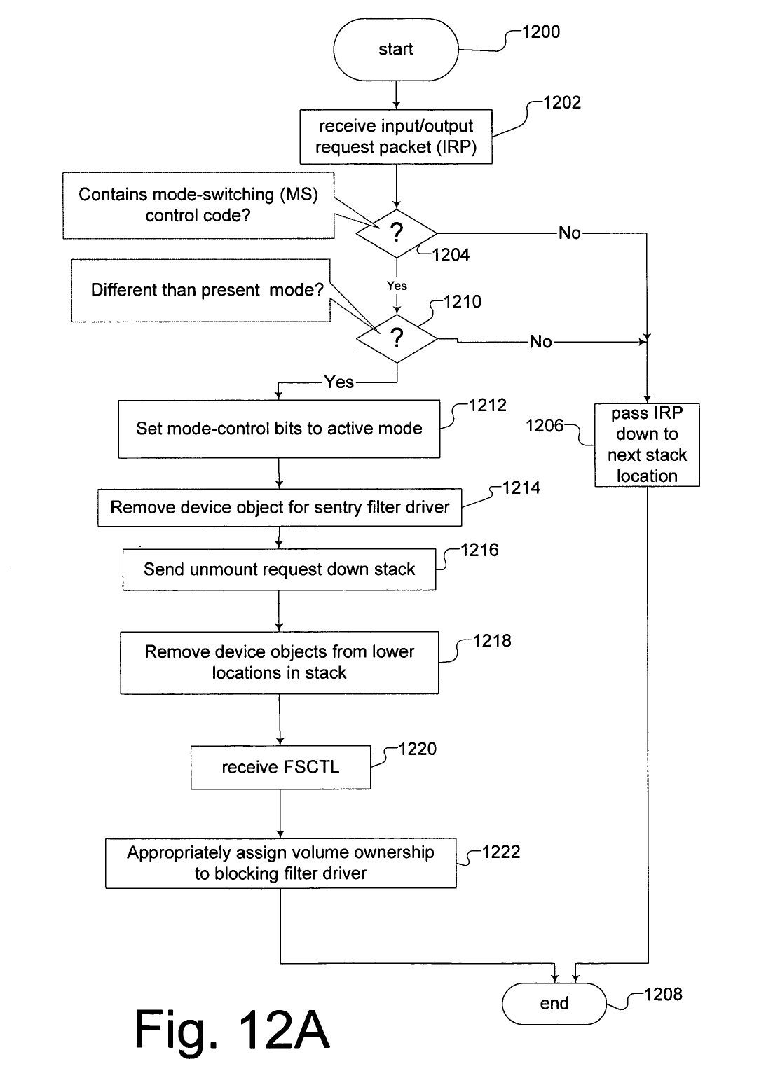

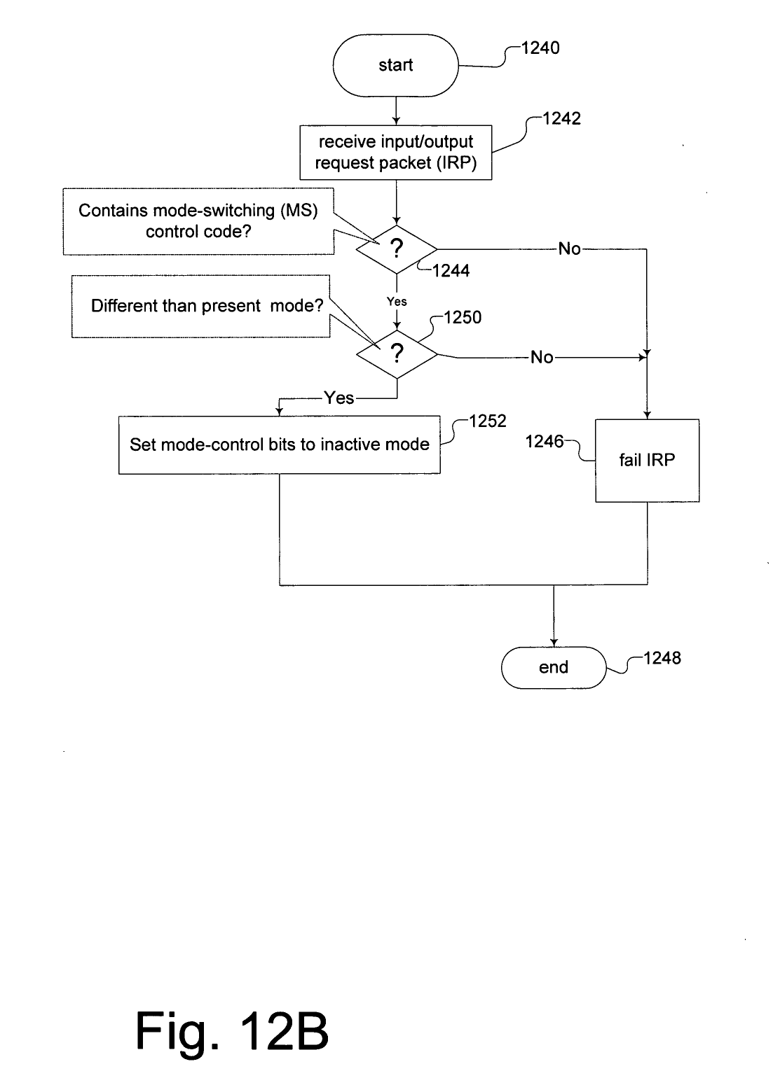

A more detailed discussion of how sentry filter driver 932 handles an IRP_MJ_CREATE-containing IRP is provided with reference to the flowcharts of FIGS. 12A and 12B, according to an embodiment of the present invention. FIG. 12A concerns the transition from inactive to active mode, so it is assumed as a starting point for discussion of FIG. 12A that blocking filter driver 920 is in the inactive mode and that stack 902 exists. Flow starts at block 1200 and proceeds to block 1202, where the IRP_MJ_CREATE-containing IRP is received by sentry filter driver 932 via sentry filter driver DO 934. Then flow proceeds to decision block 1204, where SENTRY filter driver 932 determines if the MS control-code is present in the IRP. If not, then flow proceeds to block 1206, where the IRP is passed down to the next device object in the stack (which in the inactive mode is file-sys DO 118). From block 1206, flow proceeds to the end at block 1208.

If it is determined at decision block 1204 by sentry filter driver 932 that the IRP contains the MS control-code, then flow proceeds to decision block 1210, where SENTRY filter driver 932 determines if the mode indicated in the IRP matches the present state, e.g., by comparing the MS control-code in the IRP against the value of the corresponding one or more mode bits in blocking-filter DO 922. If the IRP-indicated mode is not different than the present mode, then no change in mode is needed and flow proceeds to block 1206, etc.

But if it is determined at decision block 1210 that the IRP-indicated mode is different than the present mode, then flow proceeds to block 1212, where SENTRY filter driver 932 appropriately sets the value of the one or more mode bits in blocking-filter DO 922 to cause blocking filter driver 920 to switch to active mode the next time that blocking filter driver 920 receives a mount FSCTL. Then flow proceeds to block 1214, where SENTRY filter driver 932 removes its SENTRY DO 934 from stack 902. Then flow proceeds to block 1216, where SENTRY filter driver 932 sends an unmount-request down stack 902. Such an unmount-request does not require a reboot but instead only results in an incomplete tearing-down of stack 902, which, e.g., can be beneficial because it avoids the delay associated with a reboot. Flow proceeds to block 1218, where device objects lower in the stack 902/904 are removed.

Continuing with the assumption that stack 902 exists, block 1218 is to be understood as including: the unmount-request reaching file-system driver 116, which removes its file-system DO 118 and passes the unmount-request down stack 902; and the unmount-request next reaching blocking 920, which does not remove its blocking-filter DO 922 (as explained above).

At block 1220, the next mount FSCTL is received by blocking filter driver 920 (see discussion above). Then flow proceeds to block 1222, where blocking filter driver 920 appropriately assigns ownership of the volume (represented by volume DO 114) via communication with I/O manager 1000. Here, the discussion began with the assumption that the blocking filter driver 920 had been in the inactive mode, so in this circumstance blocking filter driver 920 indicates to I/O manager 1000 that it owns the volume represented by volume DO 114 in response to which I/O manager 1000 indicates blocking filter driver 920 in the VPB. At this point, device objects are attached so as to build stack 904 in the manner described above.

FIG. 12B concerns the transition from active to inactive mode, so it is assumed as a starting point for discussion of FIG. 12B that blocking filter driver 920 is in the active mode and stack 904 exists. Flow begins at block 1240 and proceeds to block 1242, where an IRP_MJ_CREATE-containing IRP is received by blocking filter driver 920 via blocking filter DO 922. Then flow proceeds to decision block 1244, where blocking filter driver 920 determines if the MS control-code is present in the IRP. If not, then flow proceeds to block 1246, where the IRP is failed. After block 1246, flow ends at block 1248.

If it is determined at decision block 1244 that the IRP contains the MS control-code, then flow proceeds to decision block 1250, where blocking filter driver 920 determines if the mode indicated in the IRP matches the present state. If the IRP-indicated mode is not different than the present mode, then no change in mode is needed and flow proceeds to block 1246, etc.

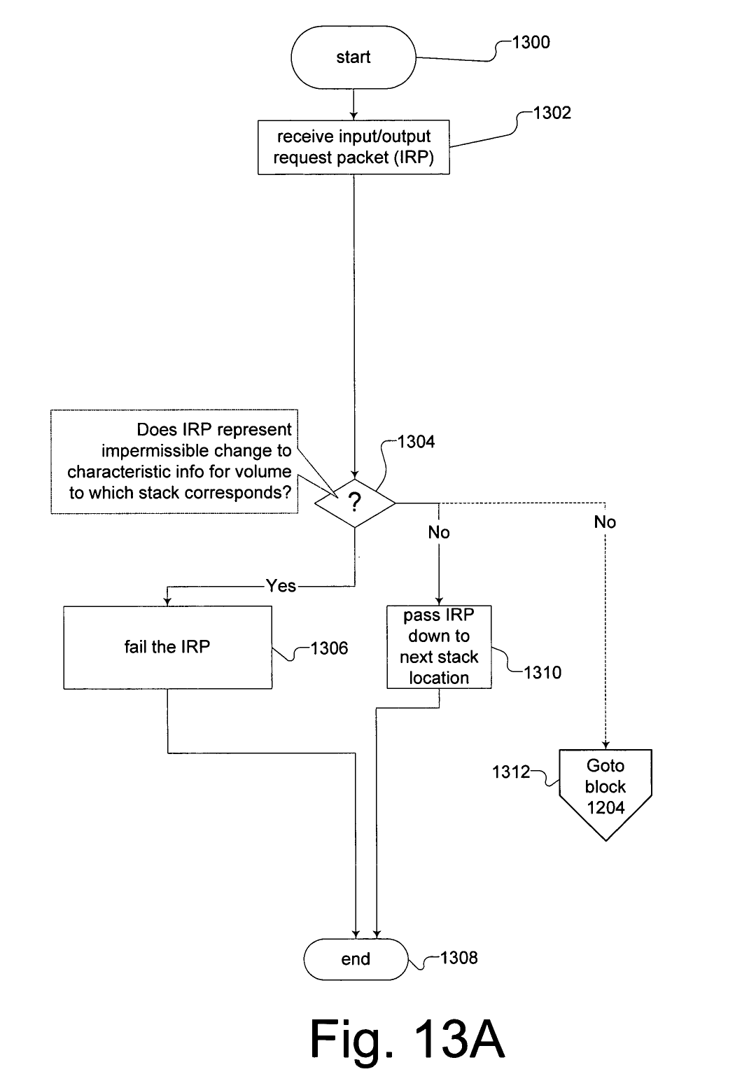

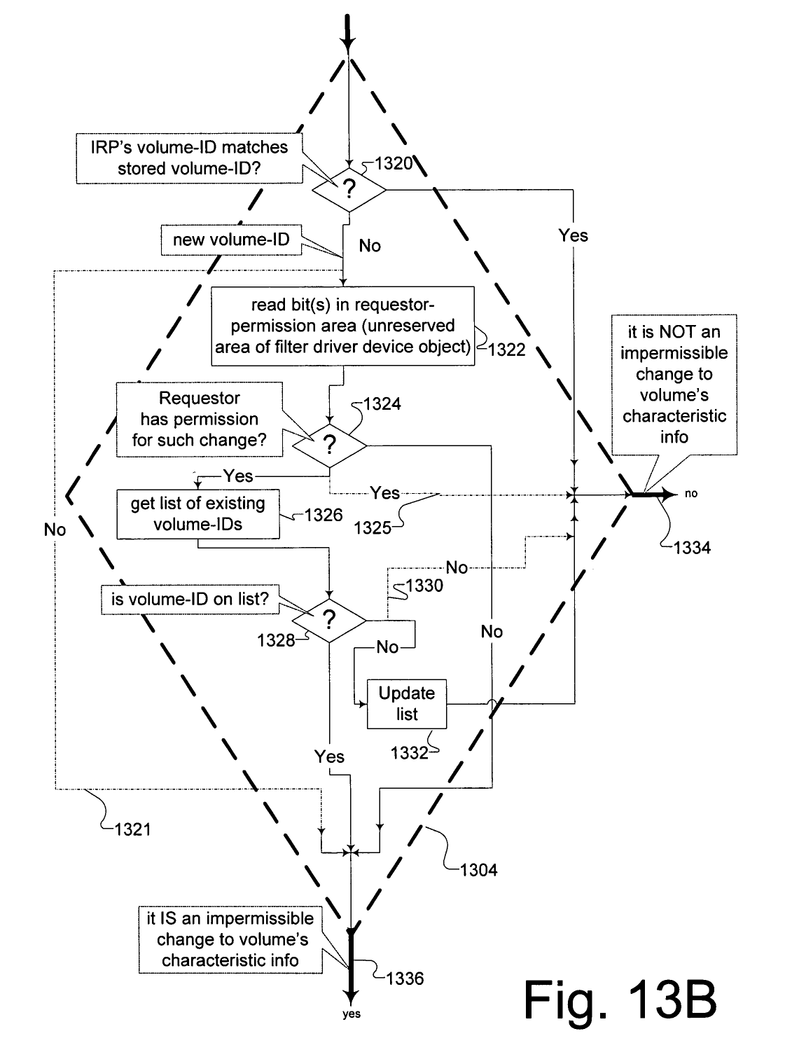

But if it is determined at decision block 1250 that the IRP-indicated mode is different than the present mode, then flow proceeds to block 1252, where blocking filter driver 920 appropriately sets the value of the one or more mode bits in the unreserved area of blocking-filter DO 922 to go into inactive mode. After block 1252, flow ends at block 1248. At this point, the stack can be thought of as a partially-completed stack 902. Building of stack 902 can continue as described above. It is noted that, when blocking filter DO 922 preexists sentry filter DO 934 (such as in a switch from active to inactive mode), blocking filter driver 920 would not forward the request for the volume-ID (arrow 1026), but instead can read the volume-ID out of blocking filter DO 922 and provide the response (a version of arrow 1034). This has an advantage, e.g., of being able to eliminate the steps represented by arrows 1026, 1028, 1030 and 1032. 1001261 The various mount-prevention mechanisms according to embodiments of the invention described above could be defeated if certain characteristic information about the volume, e.g., the volume-ID, were permitted to be changed followed by a reboot. It can be desirable to forestall such changes. FIG. 13A depicts a flowchart according to another embodiment of the invention representing a mechanism for selectively forestalling changes to volume characteristic-information that can be included in the various mount-prevention mechanisms described above. The change-forestalling mechanism of FIG. 13A is carried out at the level of device objects in the stack; in other words, at the stack-level.

In the flowchart of FIG. 13A, flow starts at block 1300 and proceeds via block 1302 (reception of the IRP) to decision block 1304, where blocking filter driver 820 (or sentry filter driver 932) determines if the IRP represents an impermissible change to characteristic information for the storage-volume to which stack 104 corresponds. If so, then flow proceeds to block 1306 where the IRP is failed, after which flow ends at block 1308. If the change is not impermissible (in other words, the change is permissible), then flow proceeds to block 1310 where the IRP is passed along, etc., after which flow ends at block 1308. Alternatively, flow proceed to block 1312 instead of block 1310. At block 1312, flow proceeds to decision block 1204 of FIG. 12B, etc.

FIG. 13B is a more detailed depiction of decision block 1304 found in the flowchart of FIG. 13A, according to an embodiment of the invention. As will be described below, a comparison will be made between the volume-ID in the IRP and the volume-ID corresponding to volume-DO 114. Thus, the capability to obtain & store the volume-ID is added to blocking filter driver 820. Similarly, the capability to store the volume-ID is added to the combination of blocking filter driver 920 and sentry filter driver 932.

In FIG. 13B, flow proceeds inside decision block 1304 to decision block 1320, where filter driver 820 or 932 determines if the volume-ID in the IRP matches the stored volume-ID. If so, the change is permissible, and flow proceeds to the “NO” output 1334 of decision block 1304. But if the volume-ID does not match, then it should be understood that the intent of the IRP is to change the volume-ID. Such a change would defeat the operation of certain filter driver embodiments according to the present invention because the stored volume-ID would no longer identify the volume to which the stack corresponds).

More particularly, at decision block 1320, filter driver 820 or 932 checks one or more fields (each containing one or more bits) in the IRP that can be indicative of the type of access being requested. If it is determined at decision block 1320 that the volume-ID in the IRP does match, then (optionally, as indicated by dashed line 1321) flow can proceed directly to the YES output 1336 of decision block 1304. Alternatively, further scrutiny of the IRP can take place, via flow proceeding from decision block 1320 to block 1322. At block 1322, filter driver 820 or 932 reads in one or more bits (representing an identifier of the entity having the requisite permission or a list of entities having the requisite permission) from a requestor-permission area (an unreserved area) in DO 822/922. Flow proceeds to decision block 1324, where filter driver 820 or 932 determines if the requesting-entity identified by the IRP has the requisite permission by comparing the requesting-entity's identifier against the identifier/list obtained at block 1322. If the requesting-entity does not have the requisite permission (if no), then flow proceeds to YES output 1336 of decision block 1304.

If it is determined at decision block 1324 in FIG. 13B that the entity requesting the change does have the requisite permission, then (optionally, as indicated by dashed line 1325) flow can proceed directly to NO output 1334 of decision block 1304. Alternatively, further scrutiny of the IRP can take place, via flow proceeding to block 1326. At block 1326, filter driver 820 or 932 reads in a list of existing (currently in use) volume-IDs. Flow then proceeds to decision block 1328.

In decision block 1328 of FIG. 13B, filter driver 820 or 932 determines if the volume-ID is not currently being used, e.g., is not on the list. If yes, then the change is not permissible, and flow proceeds to YES output 1336. But if the volume-ID is not on the list, then the change is permissible, and flow then (optionally, as indicated by dashed line 1330) can proceed directly to the NO output 1334 of decision block 1304. Alternatively, flow can proceed from the NO output of decision block 1328 to block 1332, where the list of existing volume-IDs is updated to include the volume-ID found in the IRP (that will become the new identifier of the storage-volume), and then flow can proceed to NO output 1334 of decision block 1304.

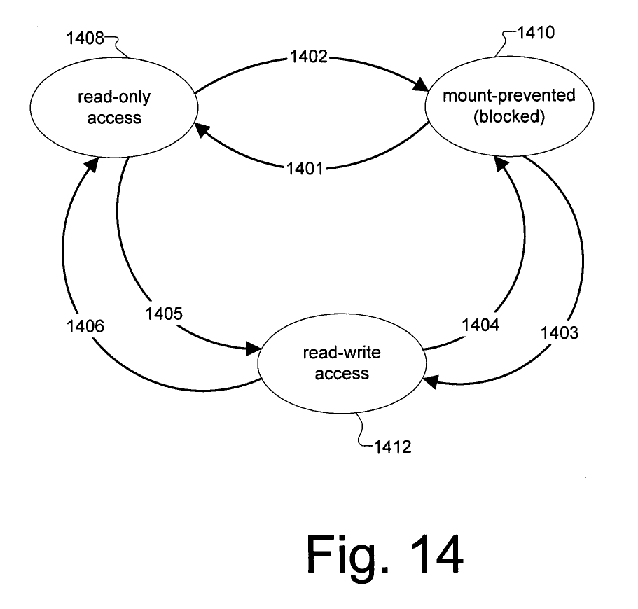

The dynamically switchable mount-prevention mechanism according to embodiments of the invention described above can be switched from active to inactive mode (that takes the form of a read-write type of read-state). It can be desirable to have a dynamically switchable mount-prevention mechanism that can be disengaged into a read-only read-state as well as a read-write-state. FIG. 14 is a state diagram depicting such operation, according to an embodiment of the present invention.

In FIG. 14, three states are depicted. State 1408 is the read-only type of access-state. State 1410 is the prevented type of access-state where I/O access is blocked. State 1412 is the read-write type of access-state where both read and write access is permitted. In FIG. 14, a first state transition 1401 goes from prevented-state 1410 to read-only state 1408. A second state transition goes from read-only state 1408 to prevented-state 1410. A third state transition goes from prevented-state 1410 to read-write state 1412. A fourth state transition goes from read-write state 1412 to prevented-state 1404. A fifth state transition goes from read-only state 1408 to read-write state 1412. A sixth state transition goes from read-write state 1412 to read-only state 1408.

Transitions 1403, 1404, 1405 and 1406 correspond to other embodiments of the present invention that have been discussed above. Transitions 1401 and 1402 will now be discussed. As will be elaborated upon below, the combined operation of another version of dynamically switchable sentry filter driver 932 (according to another embodiment of the present invention) and blocking filter driver 920 can dynamically perform transitions 1401 and 1402, as well as transitions 1403-1406. As such, read-only state 1408 and read-write state 1412 correspond to stack 902.

Previously, the one or more mode-control bits could indicate either the active or inactive mode. As the inactive mode now can take the form of a read-only type of read-state or a read-write type of read-state, the one or more control bits can be adapted to indicate any one of the three states 1408-1412. Expanding the scope of mode control bits in this manner also can replace the use of the op_status bit mentioned relative to block 606 above. Hence, block 606 would set the mode control bits in blocking filter DO 922 instead of the unreserved area in the driver object representing blocking filter driver 820.

For transition 1401 (again, from prevented-access state 1410 to read-only state 1408), the process corresponds to the flowchart of FIG. 12B. At block 1252, however, the mode control bits would be set indicate read-only state 1408. Similarly, for transition 1403, at block 1252 the mode control bits would be set to indicate read-write state 1412. For transition 1402 (again, from read-only state 1408 to prevented-access state 1410), the process corresponds to the flowchart of FIG. 12A.

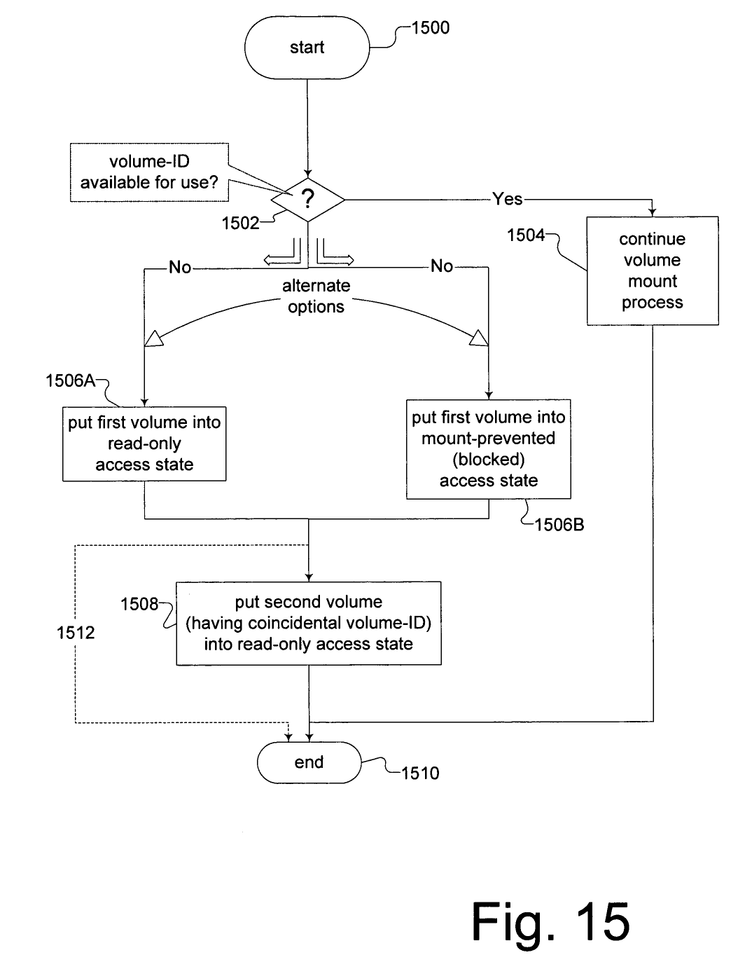

FIG. 15 depicts a flowchart according to another embodiment of the invention representing a mechanism for forestalling the use of duplicate volume identifiers (volume-IDs). When flow begins at block 1500, it is assumed that a volume-mount process is currently being attempted for a first volume and that its volume-ID has been obtained, e.g., according to one of the various embodiments described above. Flow proceeds from block 1500 to decision block 1502, where it is determined whether the volume-ID for the first volume is available for use. In other words, a check is made whether any other volumes are currently using the same volume-ID as is desired to be used for the first volume. Such a check, e.g., can be made as described above relative to FIGS. 7B or 13B. If the volume-ID is available, then flow proceeds to block 1504, where the volume mount process proceeds. After block 1504, flow ends at block 1510.

But if the volume-ID is not available for use (e.g., because it is already in use with a second volume), then proceeds from the “NO” output of decision block 1502. Alternatively, flow can proceed to either block 1506A or block 1506B. Forestalling use of duplicate volume-IDs can be accomplished by putting the first volume (namely the one intended to receive the volume-ID which is not available) into read-only state 1408 (at block 1506A) or into prevented state 1410 (at block 1506B). Again, it is possible to put the first volume into prevented state 1410 because the volume-ID is obtained before completion of the mount process. In the circumstance in which the volume-ID is not available because it is already being used for a second volume, flow can proceed from each of blocks 1506A/B to block 1508, where the second volume can be put into read-only-state 1408. Putting the first volume and (if appropriate) the second volume into such states prevents corruption of data that might otherwise result from duplicate use of a volume-ID.

After block 1508, flow ends at block 1510. Alternatively, the state of the second volume can remain unchanged. Hence as an option, flow can proceed (via dashed arrow 1512) directly to the end at block 1510.

The invention being thus described, it will be obvious that the same may be varied in many ways. Such variations are not to be regarded as a departure from the spirit and scope of the invention, and all such modifications are intended to be included within the scope of the present invention.

1. A method of forestalling use of duplicate volume identifiers (volume-IDs), at least a portion of a volume being on a storage-device such that communication between an input/output (I/O) initiator and the storage-device takes place via a stack of device objects (DOs) representing the volume, the method comprising:
determining that a first volume-ID intended for a first volume is not available for use; and
restricting access to the first volume by one of
putting the first volume into a read-only-state in which access is restricted to read-only type access, and
blocking I/O to the first volume.

2. The method of claim 1, further comprising:
performing the step of determining before completion of a mount process for the first volume.

3. The method of claim 1, further comprising:
discovering that the first volume-ID is the same as a pre-existing second volume-ID in use with a second volume.

4. The method of claim 3, further comprising:
checking if the first volume-ID is present on a list of volume-IDs in use.

5. The method of claim 1, further comprising:
switching the second volume into a read-only-state in which access is restricted to read-only type access.

6. A machine-readable medium including instructions execution of which by a machine forestalls use of duplicate volume identifiers (volume-IDs), at least a portion of a volume being on a storage-device such that communication between an input/output (I/O) initiator and the storage-device takes place via a stack of device objects (DOs) representing the volume, the machine-readable instructions comprising:
a first code segment for determining that a first volume-ID intended for a first volume is not available for use; and
a second code segment for restricting access to the first volume by one of
putting the first volume into a read-only-state in which access is restricted to read-only type access, and
blocking I/O to the first volume.

7. The machine-readable instructions of claim 6, wherein execution of the first code segment by the machine causes the volume-ID to be determined before completion of a mount process for the first volume.

8. The machine-readable instructions of claim 6, further comprising:
a code segment for discovering that the first volume-ID is the same as a pre-existing second volume-ID in use with a second volume.

9. The machine-readable instructions of claim 8, further comprising:
a code segment for switching the second volume into a read-only-state in which access is restricted to read-only type access.

10. The machine-readable instructions of claim 8, further comprising:
a code segment for checking if the first volume-ID is present on a list of volume-IDs in use.

11. An apparatus for forestalling use of duplicate volume identifiers (volume-IDs), at least a portion of a volume being on a storage-device such that communication between an input/output (I/O) initiator and the storage-device takes place via a stack of device objects (DOs) representing the volume, the apparatus comprising:
a memory in which is created the stack of device objects representing a storage-device, the stack including a filter device object (DO);
filter driver means for
determining that a first volume-ID intended for a first volume is not available for use, and
for restricting access to the first volume by one of
putting the first volume into a read-only-state in which access is restricted to read-only type access, and
blocking I/O to the first volume.
